(19) United States
(12) Patent Application Publication
(10) Pub. No.: US 2006/0088323 A1
(43) Pub. Date: Apr. 27, 2006

(54) Design support program and design support method

(75) Inventors: Akira Morisawa, Kashiwa-shi (JP); Atsushi Chaki, Kashiwa-shi (JP); Satoru Yamamoto, Abiko-shi (JP); Masahiro Serizawa, Toride-shi (JP); Hideyuki Ikegami, Abiko-shi (JP); Akiko Kanno, Kashiwa-shi (JP); Toru Ono, Moriya-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/258,499

(22) Filed: Oct. 25, 2005

(30) Foreign Application Priority Data
Oct. 26, 2004 (JP) 2004-310899
Jul. 4, 2005 (JP) 2005-194980

(51) Int. Cl. G03G 15/00

(52) U.S. Cl. 399/21

(57) ABSTRACT

A design support method which enables the verification of processing operation of software which controls a sheet conveying mechanism by displaying the process, in which a virtual sheet is conveyed, on a display portion, comprising a first procedure of setting failure occurrence conditions of a virtual device beforehand, a second procedure of judging whether the failure occurrence conditions set in the first procedure are satisfied, and a third procedure of generating a failure of a virtual device when it is judged in the second procedure that the failure occurrence conditions are satisfied.

### BACKGROUND OF THE INVENTION

1. Field of the Invention

The present invention relates to a design support program and a design support method for supporting a mechanism control design. In further detail, this relates to a design support program and a design support method of software for controlling a conveying mechanism for conveying a sheet-like conveyed object.

2. Description of the Related Art

Heretofore, the conveyance of a sheet-like conveyed object such as paper (hereafter, this is simply called a sheet) is performed in all fields. For example, in an image forming apparatus such as a copier or a printer, a sheet is conveyed by a conveying mechanism such as a roller and a guide.

When conveying a sheet, in many cases, it is rare to convey a sheet only in one direction at a constant speed. For example, it is usual to detect a position of a conveyed object by a sensor, and to make it stop in a predetermined position, or to make it turn over by performing the counter rotation of the roller. Hence, when conveying a sheet, software for controlling a mechanism by which the sheet is conveyed is indispensable.

In addition, for example, since it has been stated that image forming apparatuses in recent years have high performance and high productivity, software for controlling the image forming apparatuses has become complicated in connection with it. Hence, the man-hour of failure detection to cause determination and repairs has also increased.

Then, opportunities of using simulation technology for conveying mechanism designs have also increased with the progress in performance of computers in recent years. For example, like an invention described in Japanese Patent Application. Laid-Open No. H09-81600, a system for detecting a defect, which is latent in a conveying mechanism, by calculating the behavior of a sheet by simulation and the like are proposed.

In addition, while mechanism simulation plays an active part in all scenes, what relate to the verification of the software for controlling mechanisms are also proposed. For example, a design support method of making external events such as ON and OFF of a switch and open/close of a cover occur in printer control software from input devices such as a keyboard is proposed like an invention described in Japanese Patent Application Laid-Open No. H05-143260.

Nevertheless, the invention described in the above-mentioned Japanese Patent Application Laid-Open No. H09-81600 can find a defect which is latent in a conveying mechanism, but cannot verify the processing operation of software for controlling a conveying mechanism.

Furthermore, the invention described in the above-mentioned Japanese Patent Application Laid-Open No. H05-143260 generates a jam by an operator pushing a keyboard in suitable timing while making printer control software perform simulation operation. Hence, it is not possible to reproduce correctly the verification of operation at the time of jam occurrence which is important at the time of a design of software which controls a sheet conveying mechanism.

Thus, if a jam cannot be reproduced in a specific position and specific timing, it is not possible to perform a detailed design of control at the time of jam occurrence in the location by simulation. In addition, similarly, this means that it is not possible to verify whether a sequence at the time of jam occurrence which is designed is operating normally.

Therefore, it is necessary to perform the operation verification of software at the time of jam occurrence by a method using an actual machine. Hence, the more jam occurrence locations increase, the worse the design efficiency of sheet conveyance control is made.

### SUMMARY OF THE INVENTION

In order to solve such problems, the present invention aims at providing a design support program and a design support method which perform easily the operation verification of conveying mechanism control software at the time of an abnormal condition such as jam occurrence.

In order to achieve the above-described object, in a design support program which enables the verification of processing operation of software which controls a sheet conveying mechanism by displaying the process, in which a virtual sheet is conveyed, on a display portion and which a computer is readable, a design support program of the present invention is characterized by making a computer execute a first procedure of setting jam occurrence conditions of a virtual sheet beforehand, a second procedure of judging whether the above-mentioned jam occurrence conditions set in the above-mentioned first procedure are satisfied, and a third procedure of stopping the conveyance of the virtual sheet when it is judged that the above-mentioned jam occurrence conditions are satisfied in the above-mentioned second procedure.

In addition, in a design support method which enables the verification of processing operation of software which controls a sheet conveying mechanism by displaying the process, in which a virtual sheet is conveyed, on a display portion, a design support method of the present invention is characterized by comprising a first procedure of setting jam occurrence conditions of a virtual sheet beforehand, a second procedure of judging whether the above-mentioned jam occurrence conditions set in the above-mentioned first procedure are satisfied, and a third procedure of stopping the conveyance of the virtual sheet when it is judged in the above-mentioned second procedure that the above-mentioned jam occurrence conditions are satisfied.

Furthermore, in a design support program which enables the verification of processing operation of software which controls a sheet conveying mechanism by displaying the process, in which a virtual sheet is conveyed, on a display portion and which a computer is readable, a design support program of the present invention is characterized by making a computer execute a first procedure of setting failure occurrence conditions of a virtual device beforehand, a second procedure of judging whether the above-mentioned failure occurrence conditions set in the above-mentioned first procedure are satisfied, and a third procedure of generating a failure of a virtual device when it is judged in the above-mentioned second procedure that the above-mentioned failure occurrence conditions are satisfied.

Moreover, in a design support method which enables the verification of processing operation of software which controls a sheet conveying mechanism by displaying the process, in which a virtual sheet is conveyed, on a display portion, a design support method of the present invention is characterized by comprising a first procedure of setting failure occurrence conditions of a virtual device beforehand, a second procedure of judging whether the above-mentioned failure occurrence conditions set in the above-mentioned first procedure are satisfied, and a third procedure of generating a failure of a virtual device when it is judged in the above-mentioned second procedure that the above-mentioned failure occurrence conditions are satisfied.

Other objects and features of the present invention will become clear from the following specification and drawings.

### BRIEF DESCRIPTION OF THE DRAWINGS

FIG. 1 is a system general view in a first embodiment;

FIG. 2 is a screen shot of a design support apparatus in the first embodiment;

FIG. 3 is a jam condition setting screen shot in the first embodiment;

FIG. 4 is an image drawing of a jam setting condition in the first embodiment;

FIG. 5 is a software block diagram in the first embodiment;

FIG. 6 is a flowchart of jam occurrence in the first embodiment;

FIG. 7 is a flowchart of a sheet position calculation portion by a design support method in the first embodiment;

FIG. 8 is a schematic diagram of mechanism simulation of the design support apparatus in the first embodiment;

FIG. 9 is a flow chart showing an example of conveyance control in the first embodiment;

FIG. 10 is a software block diagram in a second embodiment;

FIG. 11 is a flowchart of jam processing in the second embodiment;

FIG. 12 is a flowchart of a sheet position calculation portion by a design support method in the second embodiment;

FIG. 13 is an image drawing of displaying jam information in a jam information display portion in the second embodiment as a warning message;

FIG. 14 is an image drawing of displaying jam information in a jam information display portion in the second embodiment with changing colors and shapes;

FIG. 15 is a control block diagram of a design support apparatus of a third embodiment;

FIG. 16 is a drawing showing an operating portion of an image forming apparatus in the third embodiment;

FIG. 17 is a jam condition setting screen shot in the third embodiment;

FIG. 18 is a software block diagram in the third embodiment;

FIG. 19 is an image drawing of displaying jam information in the third embodiment;

FIG. 20 is a software block diagram in a fourth embodiment;

FIG. 21 is a device failure setting screen shot in the fourth embodiment;

FIG. 22 is a flowchart of device failure occurrence processing in the fourth embodiment;.

FIG. 23 is an explanatory diagram of a roller OFF state failure in the forth embodiment;

FIG. 24 is a flow chart showing an example of control at the time of a roller OFF failure in the fourth embodiment;

FIG. 25 is an explanatory diagram of a roller ON state failure in the forth embodiment;

FIG. 26 is a flow chart showing an example of control at the time of a roller ON failure in the fourth embodiment;

FIG. 27 is an explanatory diagram of a sensor OFF state failure in the forth embodiment;

FIG. 28 is an explanatory diagram of a sensor ON state failure in the forth embodiment;

FIG. 29 is a flow chart showing an example of control at the time of a sensor ON failure in the fourth embodiment;

FIG. 30 is a flow chart showing an example of control at the time of a sensor stay/jam processing in the fourth embodiment;

FIG. 31 is an explanatory diagram of a motor OFF state failure in the forth embodiment;

FIG. 32 is an explanatory diagram of a motor ON state failure in the forth embodiment;

FIGS. 33A, 33B and 33C are explanatory diagrams of plural locations of device failures in the fourth embodiment;

FIG. 34 is a software block diagram in a fifth embodiment;

FIG. 35 is a display image drawing of a device failure condition setting screen in the fifth embodiment; and

FIG. 36 is a display image drawing of a warning screen of a design support apparatus in the fifth embodiment.

### DESCRIPTION OF THE PREFERRED EMBODIMENTS

Hereafter, a design support apparatus according to the present invention will be explained in detail with conforming to drawings.

### Embodiment 1

First, a first embodiment will be described. In this embodiment, in sheet conveying simulation, conditions for a jam occurring are set beforehand, and when the set conditions are reached, the conveyance of a virtual sheet is stopped and a jam is generated. Here, the expression “virtual” is used since it means an imaginary sheet on simulation.

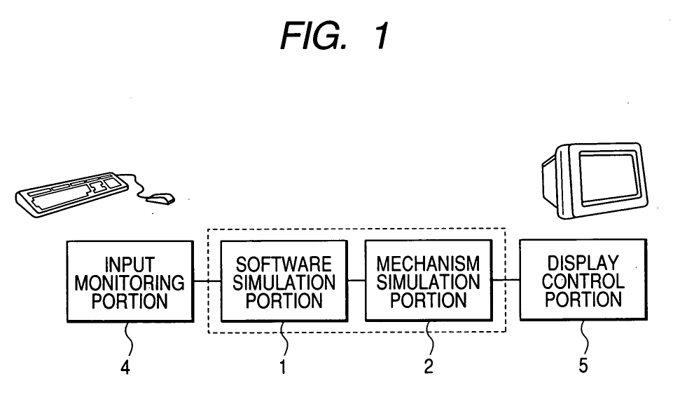

FIG. 1 shows a design support apparatus according to this embodiment. The design support apparatus of this embodiment is a sheet conveyance simulator which can perform the sheet conveying simulation of an image forming apparatus on a personal computer. In addition, this supports a control timing design of firm software which controls an image forming apparatus in the real world, and makes it possible to verify the processing operation of the firm software.

A software simulation portion 1 is a portion for executing firm software about sheet conveyance control virtually on a personal computer. An input monitoring portion 4 monitors an input of a keyboard device and a mouse which are man machine interfaces. In addition, the above-mentioned software simulation portion 1 starts software simulation control in response to an execution start request from the above-mentioned input monitoring portion 4.

The execution result of software simulation is passed to a mechanism simulation portion 2. The mechanism simulation portion 2 obtains in what part within a sheet conveying mechanism a virtual sheet exists from the velocity of a virtual roller in connection with sheet conveyance control, and the like by calculation. Then, positional information of the virtual sheet which is obtained is passed to the software simulation portion 1 or a display control portion 5.

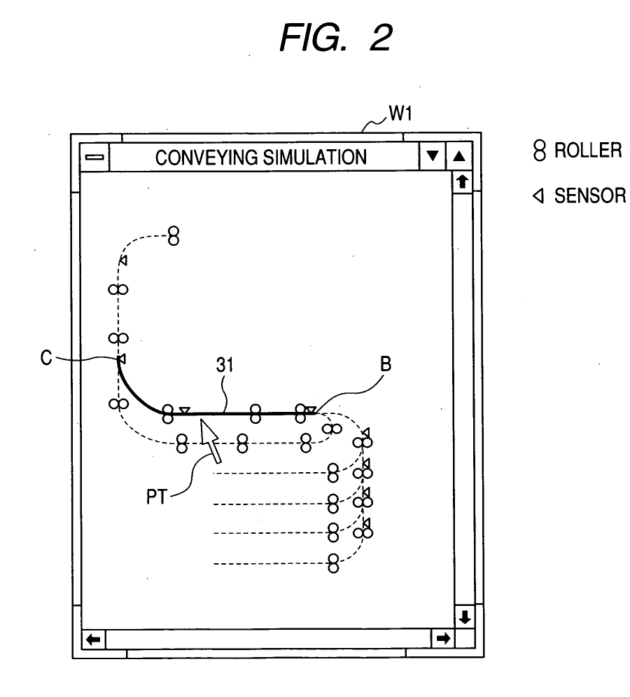

FIG. 2 shows a display example of a sheet conveying simulation screen W1 shown on a display accompanying a personal computer by the display control portion 5. On the sheet conveying simulation screen W1, a virtual sheet conveying path and a virtual roller are shown by a dotted line and a circle respectively, and a virtual sensor and a virtual sheet are shown by a triangle and a continuous line respectively.

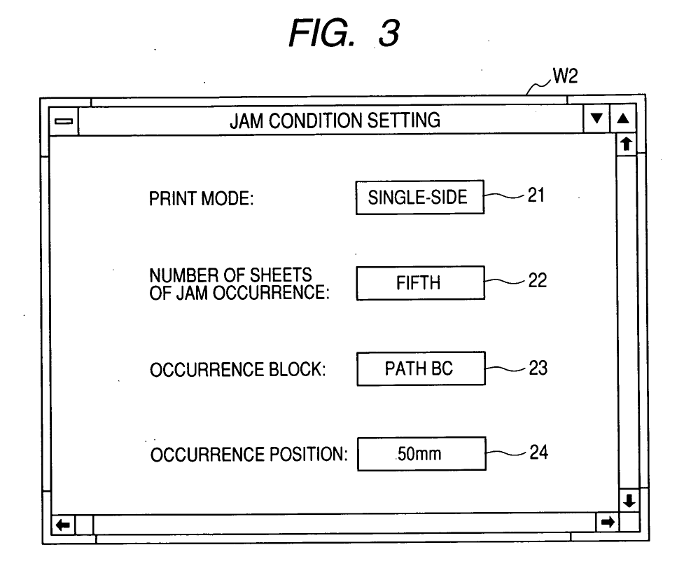

When the virtual sheet conveying path where a jam is generated is designated by a mouse cursor PT on the sheet conveying simulation screen W1, a jam condition setting screen W2 as shown in FIG. 3 is displayed. In addition, a path block 31 of FIG. 2 is designated by the mouse cursor PT. Here, a path block means a block obtained by the block division of the sheet conveying path.

On the jam condition setting screen W2, it is possible to set and register conditions of a jam generated at the time of sheet conveying simulation beforehand.

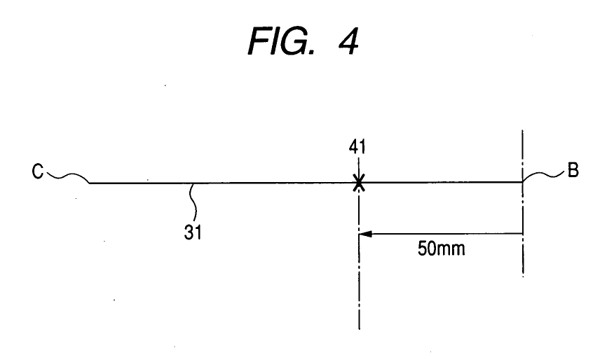

On the jam condition setting screen W2, a user can input conditions of generating a jam. A print mode setting area 21 where a print mode of the image forming apparatus is set, a number-of-sheets setting area 22 where it is set on what number sheet a jam occurs, and a path block setting area 23 where a path block in which a jam occurs is designated are provided on the jam condition setting screen W2. In addition, a jam occurrence position setting area 24 where a position where a jam occurs is set by inputting distance from a reference position mentioned later in FIG. 4 is also provided on the jam condition setting screen W2.

As to jam conditions, it is possible to perform setting by various combinations of a print mode in which a jam occurs, a number of sheets at which a jam occurs, and a position in which a jam occurs, according to setting contents in the respective setting areas 21 to 24.

FIG. 4 shows schematically an occurrence position of a jam set on the jam condition setting screen W2 of FIG. 3. In an example shown in FIGS. 3 and 4, when designating an occurrence position of a jam, a point B which is an upper edge of a path BC is made a reference position, and a position 41 which is apart by 50 mm from there to a downstream direction (a direction from the point B to a point C) is registered as a jam occurrence position.

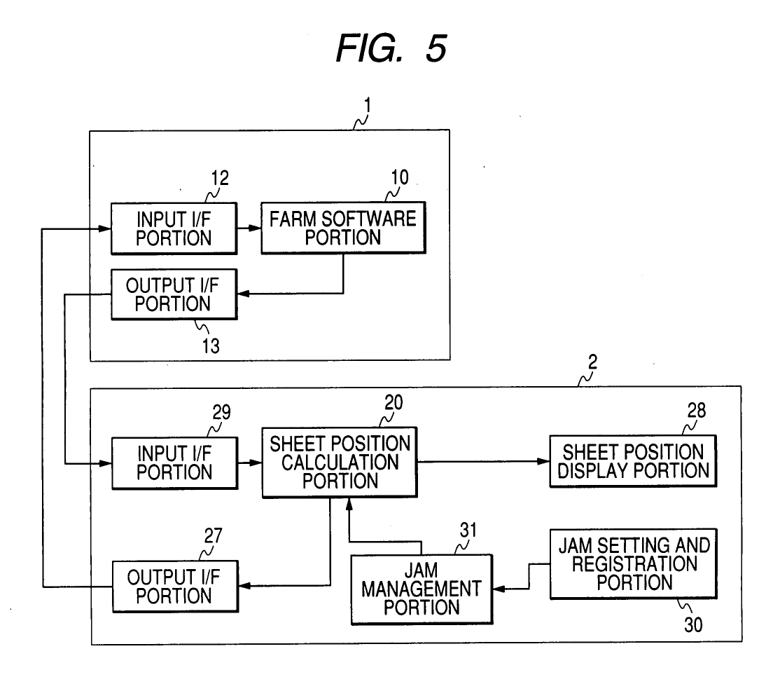

FIG. 5 shows an aspect of the software simulation portion 1 and mechanism simulation portion 2 of the design support apparatus in this embodiment.

The software simulation portion 1 is constituted of a firm software portion 10, an input I/F portion 12, and an output I/F portion 13.

The firm software portion 10 is software for performing the sheet conveyance control of the image forming apparatus in the real world.

The input I/F portion 12 is a portion which inputs information from the mechanism simulation portion 2. The output I/F portion 13 is a portion which outputs information to the mechanism simulation portion 2.

The mechanism simulation portion 2 is constituted of a sheet position calculation portion 20, an input I/F portion 29, an output I/F portion 27, a sheet position display portion 28, a jam management portion 31, and a jam setting and registration portion 30.

The input I/F portion 29 is a portion which receives output result from the output I/F portion 13 of the software simulation portion 1, and is the portion for passing the control information of various devices, such as a virtual motor, a virtual clutch and a virtual flapper which relate to sheet conveyance control, to a downstream stage.

The sheet position calculation portion 20 is a portion for calculating conveying speed on a virtual sheet conveying path from the control information of the virtual motor, virtual clutch and virtual flapper which relate to the sheet conveyance control, and calculating a front edge position and a rear edge position of the virtual sheet.

The sheet position display portion 28 is a portion for instructing the display control portion 5 to display the above-mentioned sheet conveying simulation screen W1 on the basis of the front edge position and the rear edge position of the virtual sheet which are calculated by the sheet position calculation portion 20 which is the preceding stage.

In addition, the sheet position calculation portion 20 generates a jam sequence on the basis of the jam information which is set and registered in the jam management portion 31 mentioned later, and also has a role of stopping sheet conveyance when jam conditions are satisfied.

The output I/F portion 27 is a portion for giving the sheet positional information set by the sheet position calculation portion 20, which is the preceding stage, to the input I/F portion 12 of the software simulation portion 1.

The jam setting and registration portion 30 receives conditions for a jam occurring, on a screen as shown in FIG. 3, and sets to the jam management portion 31 the jam information which the jam setting and registration portion 30 receives.

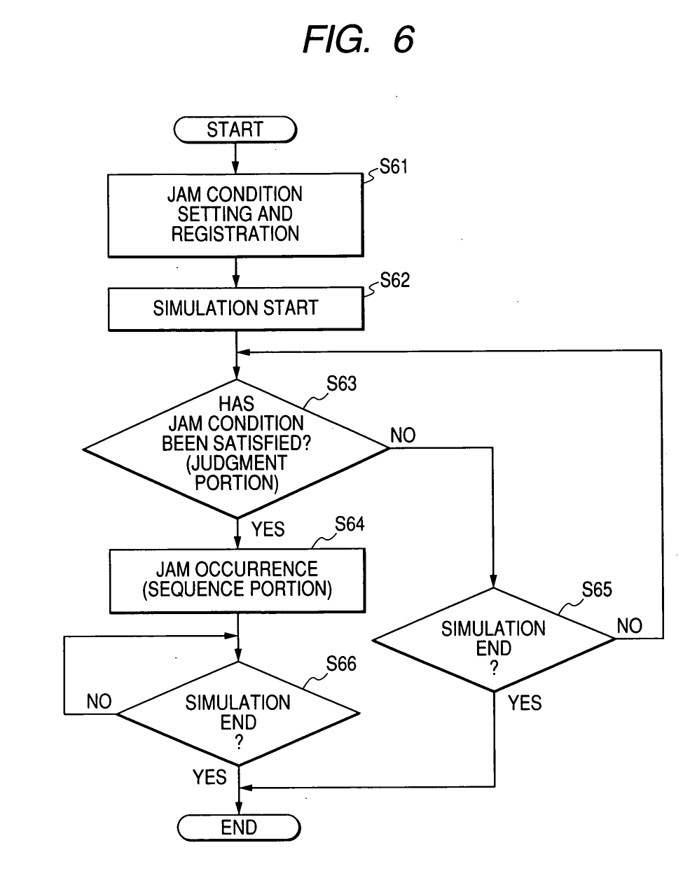

FIG. 6 is a flowchart of jam occurrence in the first embodiment. First, jam occurrence conditions are set in the jam setting and registration portion 30 before simulation start of sheet conveyance, and the set jam conditions are set to the jam management portion 31 (S61).

Next, the simulation start of sheet conveyance is instructed with a pointing device such as a keyboard 3. According to the start instruction of this sheet conveying simulation, the software simulation portion 1 and the mechanism simulation portion 2 are operated, and simulation is started (S62).

By the sheet position control in the mechanism simulation portion 2 mentioned later, it is judged whether jam conditions set beforehand are reached, with calculating a position of the virtual sheet, and the satisfaction of the jam occurrence conditions is judged (S63).

If a jam is generated at step S63, the conveyance of the virtual sheet on which the jam is generated is stopped and a jam sequence is generated (S64). End of simulation is judged if jam conditions are not satisfied at step S63 (S65). When judging that simulation is ended at step S65, all the processing is terminated (S66).

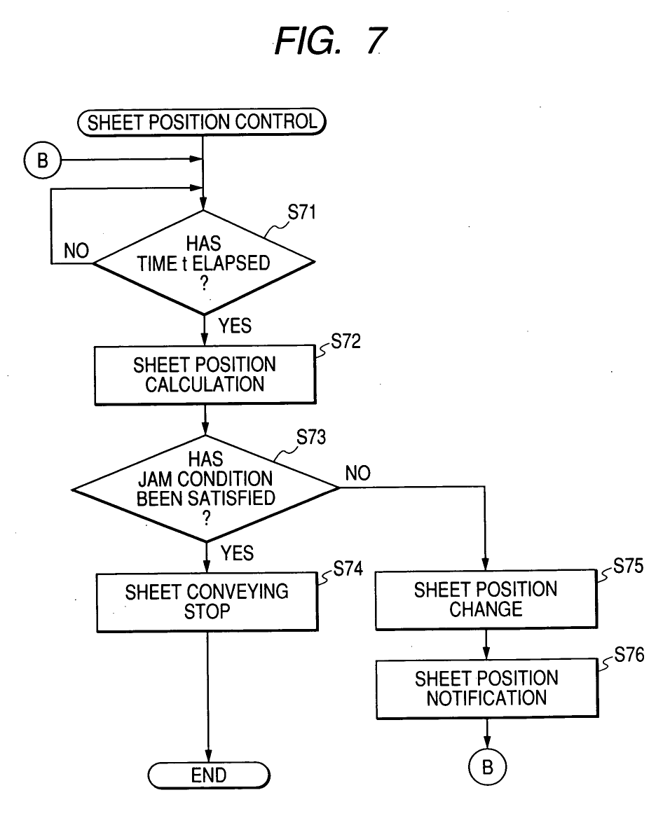

FIG. 7 is a flowchart of the sheet position calculation portion 20. The sheet position calculation portion 20 performs processing at predetermined intervals of t first (S71). Then, a position of the virtual sheet P is calculated by obtaining distance S=v×t, in which the virtual sheet P progresses, from sheet conveying speed v and the time interval t (S72).

Here, the jam conditions (that is, in this embodiment, the sheet position, number of sheets, and print mode are made the jam occurrence conditions) managed by the jam management portion 31 are compared with the sheet position which is calculated at step S72, number of sheets, and print mode (S73).

When jam conditions are satisfied at step S73, the conveyance of the virtual sheet on which the jam is effected is stopped (S74). If jam conditions are not satisfied at step S73, the jam condition concerned is updated into a sheet position newly calculated at step S74. The updated positional information is passed to the sheet position display portion 28, and is displayed on the sheet conveying simulation screen W1 (S75).

The sheet position change at step S75 is passed to the output I/F portion 27 (S76). The output I/F portion 27 outputs sheet positional information to the input I/F portion 12 of the software simulation portion 1.

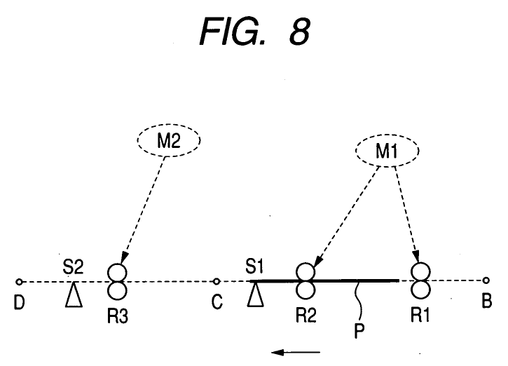

Next, description in accordance with actual simulation operation will be added using FIG. 8. FIG. 8 shows an example of arrangement of various devices relating to sheet conveyance control. The following matters are required of sheet conveyance control. The virtual sheet P is conveyed in the continuous arrow direction on the path BC by the virtual roller R1.

The virtual roller R1 is driven by the virtual motor M1. The virtual sheet P is advanced to the path BC in the timing when a front edge of the virtual sheet P passes the virtual sensor S1. Then, a virtual motor M2 is turned on and the virtual sheet P is advanced to a path CD. A dotted arrow shows drive relation.

A designer instructs the start of sheet conveying simulation from a keyboard device, a mouse, or the like. Then, the software simulation portion 1 and mechanism simulation portion 2 are executed by an operating system 7 (not shown) through the input monitoring portion 4.

When the software simulation portion 1 is started, the firm software portion 10 executes serially software for performing sheet conveyance control of the image forming apparatus in the real world with cooperating with the operating system 7.

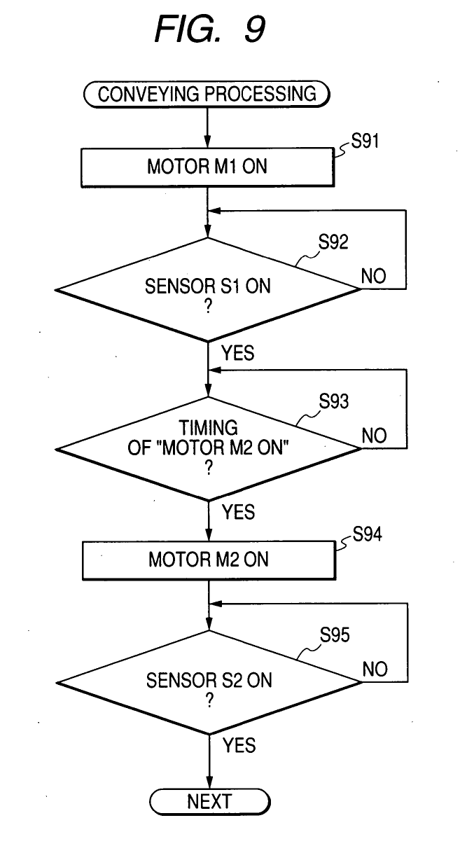

The firm software portion 10 performs sheet conveyance control according to the flowchart of FIG. 9. When the virtual sheet P arrives at a predetermined position, the virtual motor M1 is made to turn on (S91). Then, it is waited that the virtual sensor S1 turns on (S92). When S1 is turned on, it is waited that the front edge of the virtual sheet P arrives at 10 mm in the upstream of the virtual roller R2 (S93) and the virtual motor M2 is turned on (S94). Next, it is waited that the virtual sensor S2 is turned on (S95). The virtual roller R1 connected is rotated on the basis of the information that the virtual motor M1 is turned on at step S91.

Hence, the sheet position calculation portion 20 updates a position of the virtual sheet P according to the rotation of the virtual roller R1, gives the ON information of the virtual sensor S1 to the firm software portion 10 through the output I/F portion 25 in the timing when the virtual sheet P reaches the virtual sensor S1, and escapes from the wait processing at step S92.

Processing at step S93 is waiting processing in which the firm software portion 10 takes timing on the basis of step S92. The virtual roller R2 connected is rotated on the basis of the information that the virtual motor M2 is turned on at step S94.

Hence, the sheet position calculation portion 20 updates a position of the virtual sheet P according to the rotation of the virtual roller R2, gives the ON information of the virtual sensor S2 to the firm software portion 10 through the output I/F portion 25 in the timing when the virtual sheet P reaches the virtual sensor S2, and escapes from the wait processing at step S95.

In addition, as for a jam occurrence position, although the method of a path block/distance of the path block from a reference position is described, it is not limit to this method in particular. For example, it is also good to combine a feed port with the distance from the feed port toward a downstream. In addition, it is acceptable to adopt a method of combining a virtual sensor, which exists in a conveying path, with distance from the virtual sensor toward the upstream or downstream.

### Embodiment 2

Next, a second embodiment will be described. This embodiment sets beforehand conditions for generating a jam, and displays a warning that the jam is generated while generating the jam when the set conditions are satisfied.

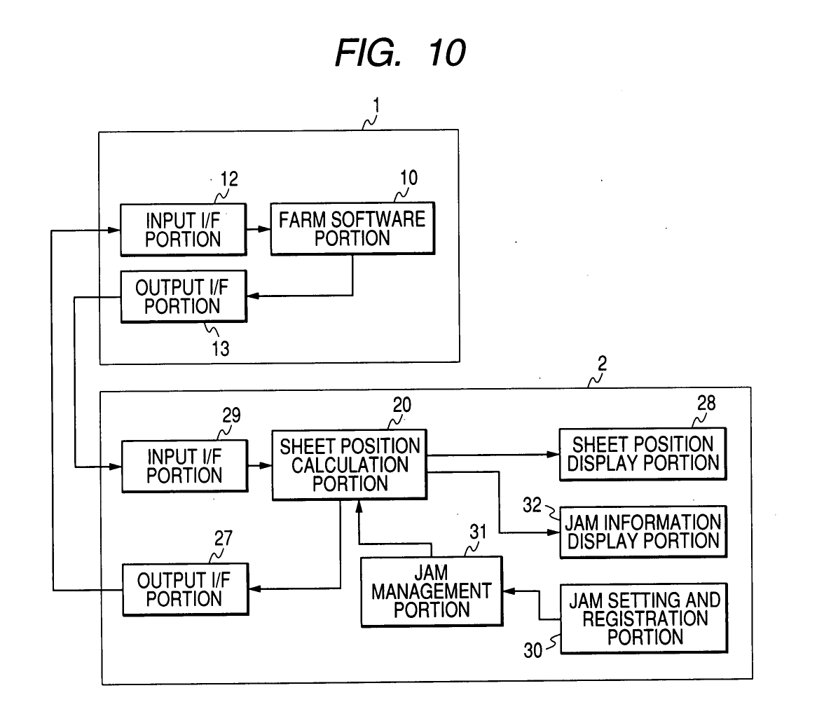

FIG. 10 shows an aspect of the software simulation portion 1 and mechanism simulation portion 2 of the design support apparatus in the second embodiment. Those whose drawings and reference numerals are the same as those in the first embodiment are made the same.

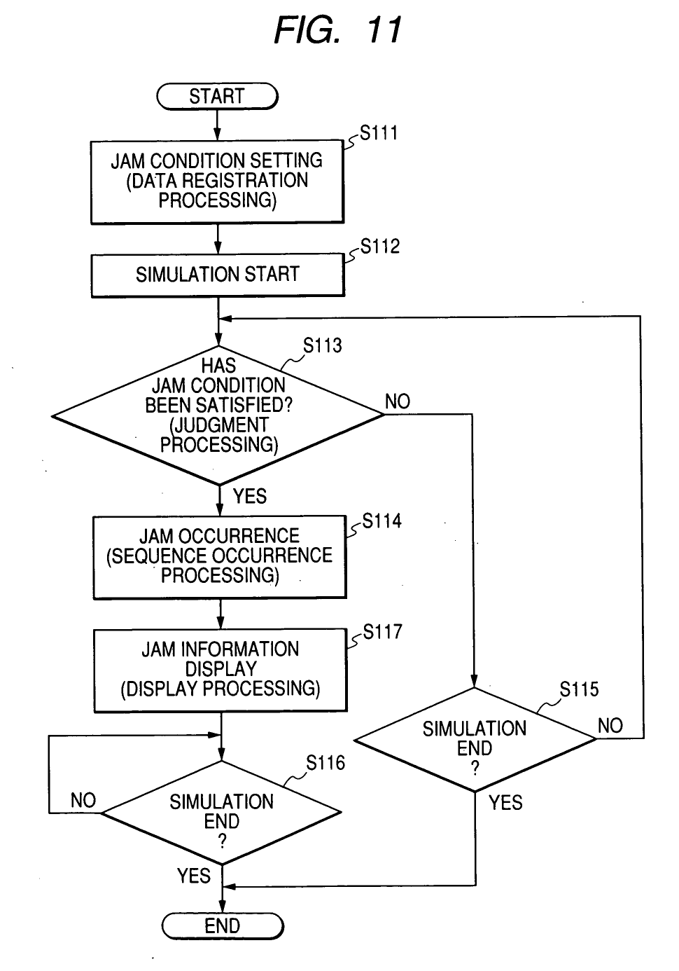

FIG. 11 shows a flow of jam occurrence in the second embodiment. Since steps S111 to 116 are the same processing as that in the first embodiment, its description is omitted, and step S117 added in a jam information display portion 32 will be described.

When a jam sequence occurs at step S114, the sheet position calculation portion 20 notifies the jam information display portion 32 of jam occurrence to pass the information of the generated jam. The jam information display portion 32 performs display on a display on the basis of the jam information received.

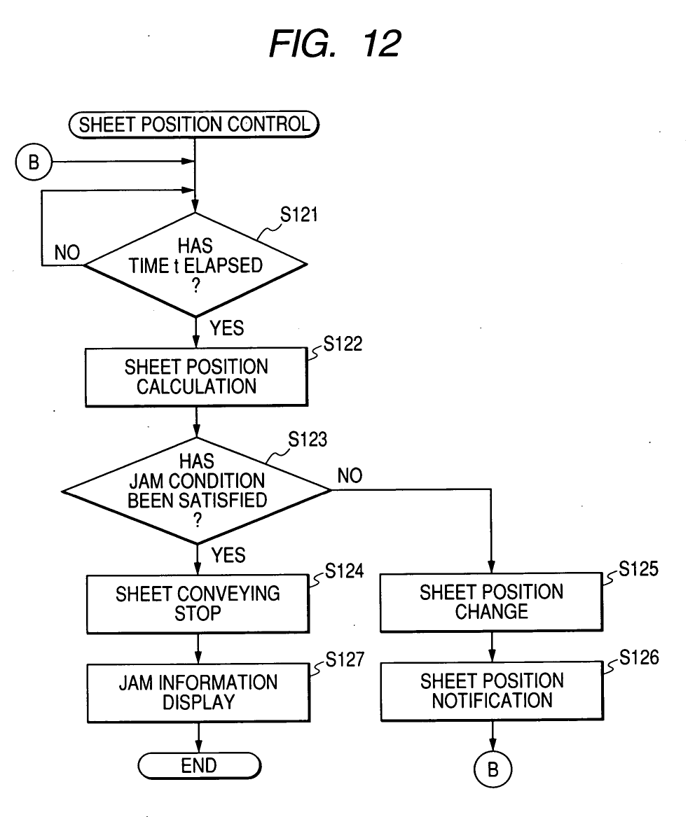

FIG. 12 is a flowchart of the sheet position calculation portion 20. Since processing at steps S121 to 126 are the same as that in the first embodiment, its description will be omitted. In this embodiment, the processing of performing display on a display on the basis of the jam information at step S127 is added.

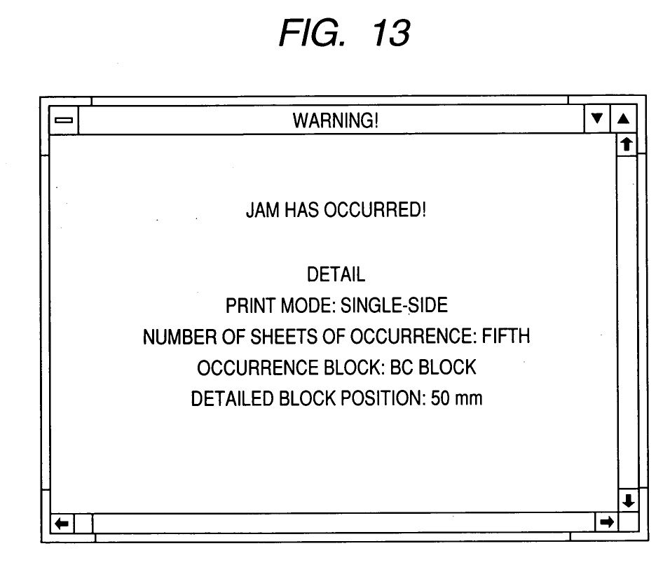

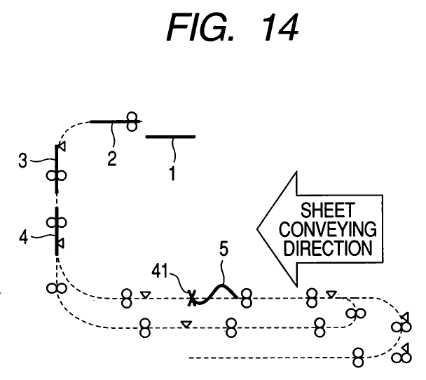

Display images of the jam information performed at step S127 are shown in FIGS. 13 and 14. FIG. 13 performs popup display by making jam information into a warning message. Specifically, a print mode, a number of sheets, and a position of a jam generated are displayed.

FIG. 14 displays on the sheet conveying simulation screen W1 an example at the time of performing display with changing a form of a virtual sheet on which the jam occurs so that a position where the jam occurs may be known. At this time, this screen W1 displays the virtual sheet, on which the jam occurs, with applying a number, which denotes what number virtual sheet, to the virtual sheet so that it may be understood what number the vertical sheet on which the jam occurs is. In addition, numbers which denote what numbers the virtual sheets besides the virtual sheet on which the jam occurs are applied.

In the case of display in FIG. 14, in order that the virtual sheet on which the jam occurs may be clearly known, it is also good to change the color of the jammed sheet. In addition, although not shown, it is also acceptable to mark a position where the jam occurs.

### Embodiment 3

Next, a third embodiment will be described. Also in this embodiment, conditions that a jam occurs are set beforehand, and when the set conditions are reached, a jam is generated. Nevertheless, this differs in that sheet conveying simulation is displayed on a touch-sensitive panel display 50 which is provided in the operating portion 17 of an image forming apparatus.

In addition, in this embodiment, since a conveyance state of a sheet and an occurrence state of a jam are displayed on the touch-sensitive panel display 50 with making the sheet actually conveyed by a roller, the expression “virtual” is not used.

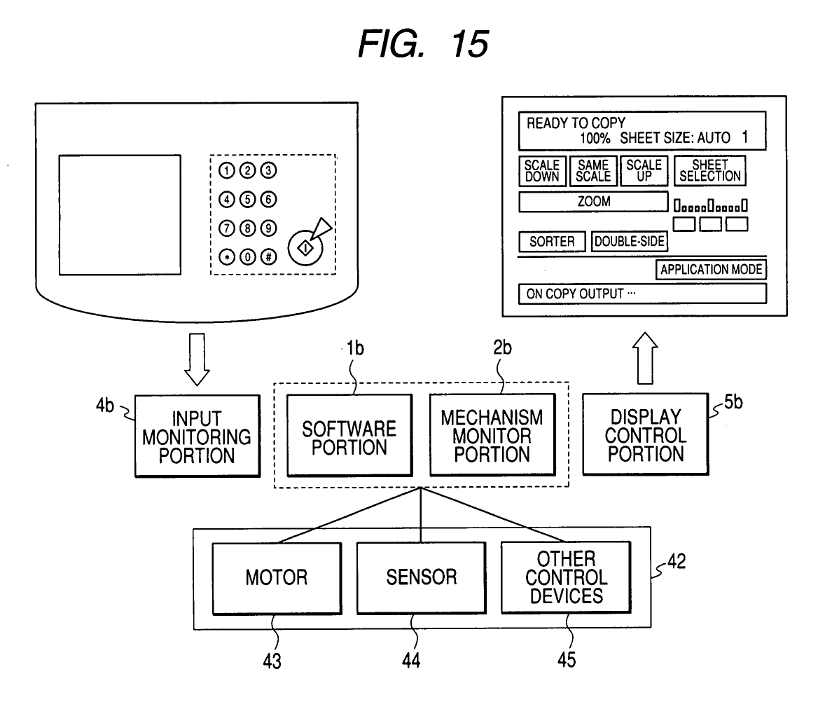

FIG. 15 shows a design support apparatus according to the present invention. The design support apparatus of this embodiment can display a sheet conveyance state of an image forming apparatus within the image forming apparatus, and is used for supporting a control timing design of firm software which controls the image forming apparatus.

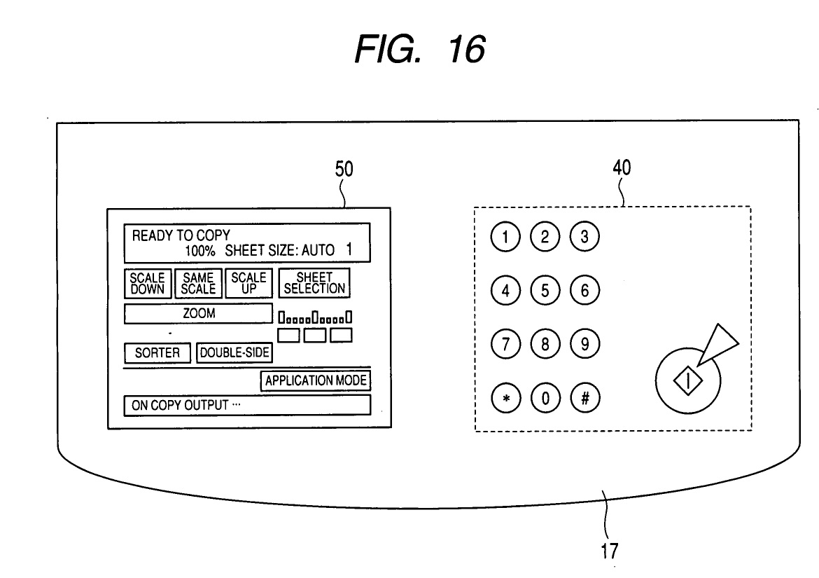

The software portion 1b is built-in software relating to sheet conveyance control. The input monitoring portion 4b monitors an input of the touch-sensitive panel display 50, a ten key 40, and the like which are man machine interfaces and are shown in FIG. 16. The touch-sensitive panel display 50 and ten key 40 are provided in the operating portion 17 of the image forming apparatus.

Motors 43 and other control devices 45 within the sheet conveying mechanism 42 of the image forming apparatus are controlled by the execution of software portion 2b. The move result of a sheet is fed back to the software portion 1b by a sensor 44.

In addition, the execution result of the software portion 1b is passed to the mechanism monitor portion 2b. In the mechanism monitor portion 2b, it is obtained in which part within the sheet conveying mechanism 42 a sheet exists from the velocity of a roller relating to sheet conveyance control and the like by calculation, and it is passed to the display control portion 5b.

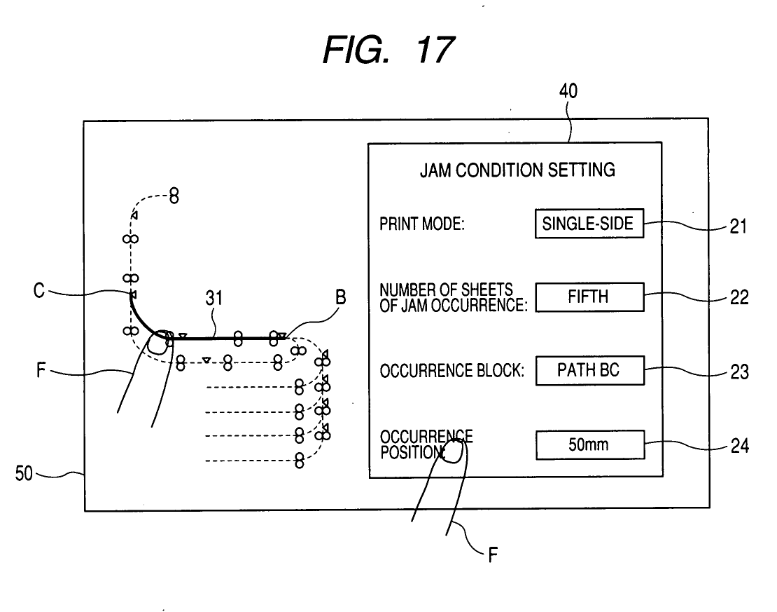

A sheet conveyance display screen as shown in FIG. 17 is displayed on the touch-sensitive panel display 50 by the display control portion 5b.

When a midpoint between branch points B and C on the sheet conveyance display screen of FIG. 17 is pointed by a finger F or the like, jam condition setting is displayed. On the jam condition setting (21 to 24), it is possible to register conditions for generating a jam. A numerical input can be performed with the ten key 40. Details are the same as those in the first example.

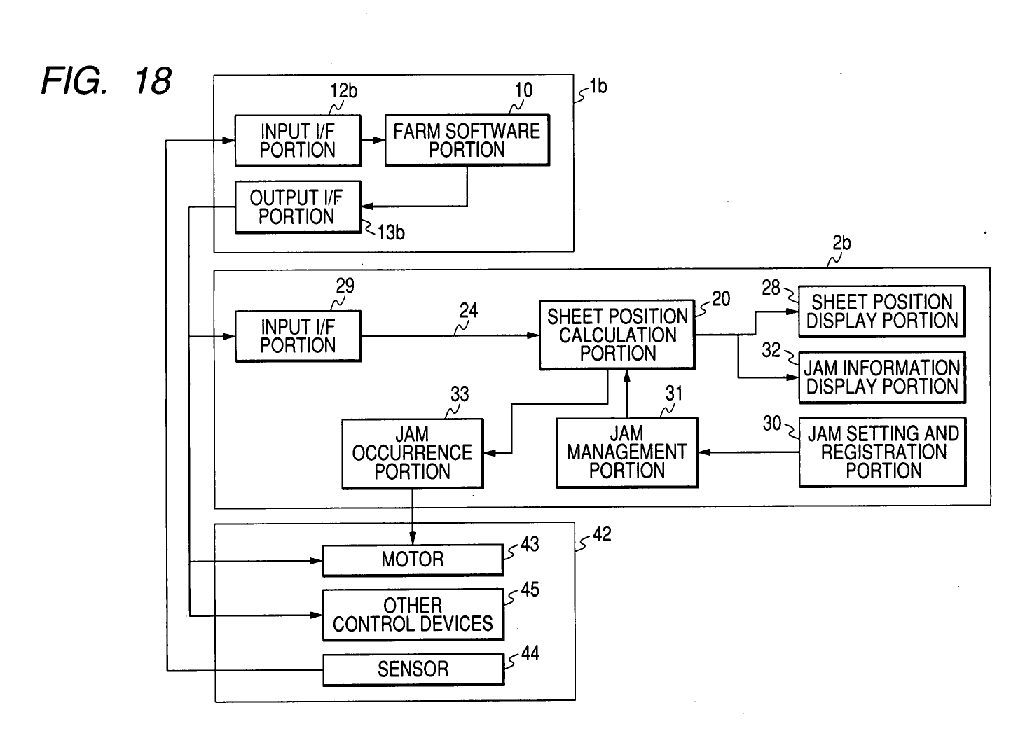

FIG. 18 shows an aspect of the software portion 1b, mechanism monitor portion 2b, and sheet conveying mechanism 42 of the design support apparatus of this embodiment. In addition, the software portion 1b and mechanism monitor portion 2b are omitted because of no relation to a main object of description.

The software portion 1b is constituted of the firm software portion 10, an input I/F portion 12b, and an output I/F portion 13b. The firm software portion 10 is software for performing sheet conveyance control of the image forming apparatus.

The input I/F portion 12b is a portion of inputting information from the sheet conveying mechanism 42. The output I/F portion 13b is a portion of outputting information to the sheet conveying mechanism 42 and mechanism monitor portion 2b.

The mechanism monitor portion 2b is constituted of a jam occurrence portion 33, the sheet position calculation portion 20, input I/F portion 29, jam management portion 31, sheet position display portion 28, jam setting and registration portion 30, and jam information display portion 32. Main structure is the same as that in the first embodiment.

In the first embodiment, since there is no feedback by a sensor to the software simulation portion 1, the sheet position calculation portion 20 generates a jam. Nevertheless, since there is the sheet conveying mechanism. 42 in this embodiment, it is unnecessary.

In addition, when the sheet position calculation portion judges in sheet conveying simulation that the jam conditions registered in the jam management portion 31 are satisfied, the jam occurrence portion 33 searches a motor which coincides with jam conditions from the motors 43 of the image forming apparatus, and has a role of directly stopping drive. The sheet conveying mechanism 42 is constituted of the motors 43, sensor 44, and other control devices 45.

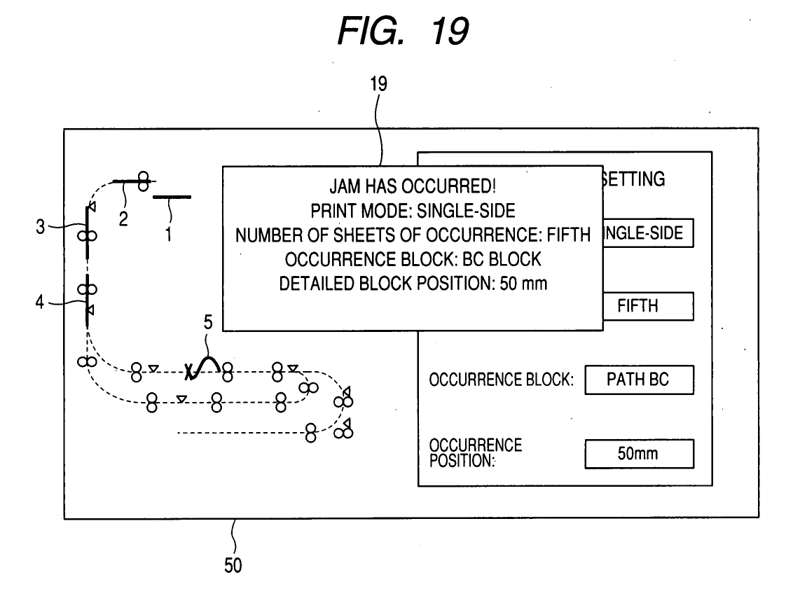

Similarly to the first embodiment, the actual sheet conveying mechanism 42 has the arrangement shown in FIG. 8, and the firm software portion 10 performs sheet conveyance control according to the flowchart of FIG. 9. When a jam is generated, warning display shown in FIG. 19 is displayed on the touch-sensitive panel display 50.

Jam condition setting and registration as shown in FIG. 17 are not limited to the form, but, for example, it is also good to record it beforehand in a data file as setup data, and to read it before starting the design support apparatus according to this embodiment.

In addition, the warning display of FIG. 19 is not limited to the form, it is also good to attract a designer's attention, for example, by changing the color of a jam occurrence position, changing a shape, performing enlarged display, or displaying a marker, on the sheet conveying simulation screen W1 of FIG. 2.

As described above, according to the first to third embodiments of the present invention, in advance of simulation operation, it is possible to set and register the generating conditions of a jam generated inside a conveying mechanism. As set contents, it is possible to set and register the setting of detailed conditions obtained by combining freely a designated position within a conveying path, a designated number of sheets, and a print mode as the conditions of jam occurrence. Thereby, it is possible to verify a jam sequence by the firm software in a location, where timing in sheet conveyance is severe, and other critical locations. Hence, it is possible to perform efficiently the verification and a design of the firm software which performs sheet conveyance control.

Thus, according to this embodiment, it is possible to reproduce the occurrence of a jam with a real system and to perform efficiently the Operation verification of the conveying mechanism control software at the time of a device failure.

### Embodiment 4

Next, a fourth embodiment will be described. In this embodiment, in sheet conveying simulation, conditions that a failure of a virtual device occurs are set beforehand, an d when the set conditions are reached, a failure state of the virtual device is generated.

When controlling the behavior of a sheet by firm software, it is based on the premise that a device used as a controlled system normally operates. Therefore, when the device of the controlled system does not respond as a design or does not operate because of a certain reason at the time of sheet conveyance, firm software processes it as an abnormal state.

In such a case, if verified by a method using a real system like the conventional, the reliability of the verification itself is low since the reproduction of a failure is difficult. Furthermore, the design efficiency of sheet conveyance control is made low.

So, what is proposed in this embodiment is such a proposal that solves the above problems and efficiently verifies conveying mechanism control software at the time of an abnormal condition such as a failure of a device.

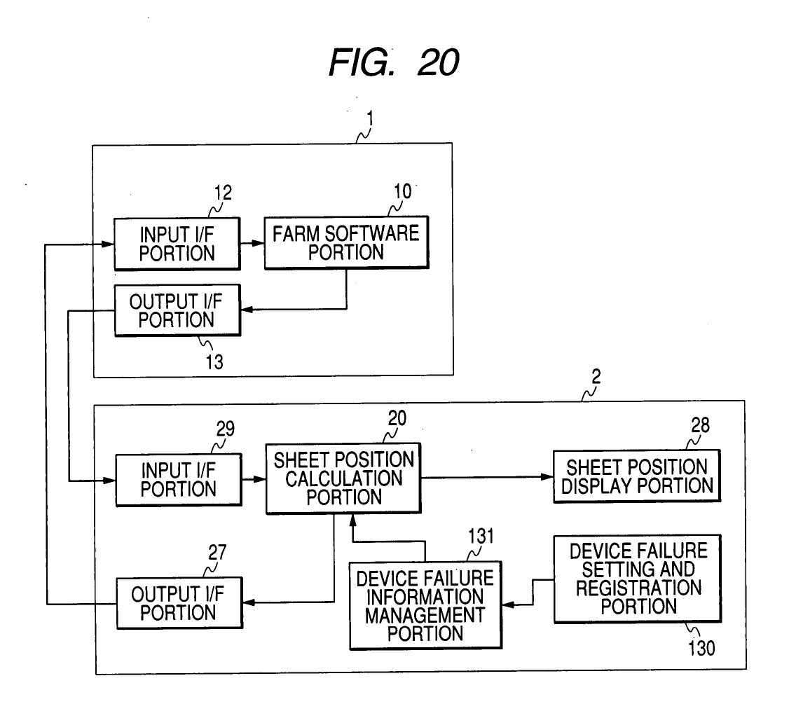

FIG. 20 shows an aspect of the software simulation portion 1 and mechanism simulation portion 2 of the design support apparatus in this embodiment. The difference from the first embodiment (FIG. 5) is a point of providing a device failure setting and registration portion 130 and a device failure information management portion 131.

The software simulation portion 1 has the same structure as that in the first embodiment. Hence, the detailed explanation about the software simulation portion 1 is omitted.

The mechanism simulation portion 2 is constituted of the sheet position calculation portion 20, input I/F portion 29, output I/F portion.27, sheet position display portion 28, device failure setting and registration portion 130 and device failure information management portion 131.

The input I/F portion 29 is a portion which receives output result from the output I/F portion 13 of the software simulation portion 1, and is the portion for passing the control information of various devices, such as a virtual motor, a virtual clutch, a virtual flapper which relate to sheet conveyance control, to a downstream stage.

The sheet position calculation portion 20 is a portion for calculating conveying speed on a virtual sheet conveying path from the control information of the virtual motor, virtual clutch, and virtual flapper which relate to the sheet conveyance control, and calculating a front edge position and a rear edge position of the virtual sheet.

The sheet position display portion 28 is a portion for instructing the display control portion 5 to display the above-mentioned sheet conveying simulation screen W1 on the basis of the front edge position and the rear edge position of the virtual sheet which are calculated by the sheet position calculation portion 20 which is the preceding stage.

In addition, the sheet position calculation portion 20 generates a failure of a set virtual device after the predetermined conditions are satisfied on the basis of the device failure information which are set and registered by the device failure information management portion 131 mentioned later. A virtual device here includes a virtual sensor, a virtual motor, a virtual clutch, a virtual flapper, and the like.

The output I/F portion 27 is a portion for giving the sheet positional information set by the sheet position calculation portion 20, which is the preceding stage, to the input I/F portion 12 of the software simulation portion 1.

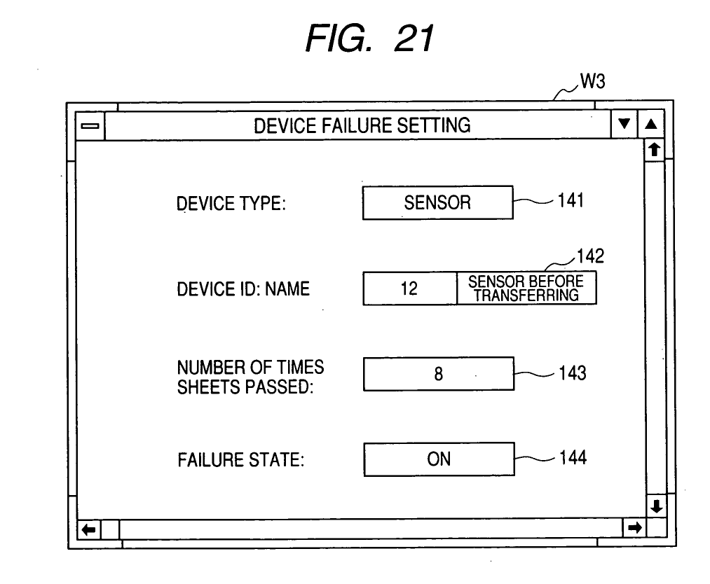

The device failure setting and registration portion 130 sets the occurrence conditions of a device failure which an operator inputs on a screen W3 shown in FIG. 21. Then, the device failure information set in the device failure setting and registration portion 130 is registered in the device failure information management portion 131.

Here, the screen W3 shown in FIG. 21 is a device failure condition setting screen which sets a failure of a device used as a cause of generating a jam. On the device failure condition setting screen W3, it is possible to set and register conditions of a device failure generated at the time of sheet conveying simulation beforehand.

The device fault condition setting screen W3 has a device type setting area 141 for setting a type of a virtual device where a failure is generated. In addition, the device failure condition setting screen W3 has a failed device setting area 142 for designating an ID of a virtual device generating a failure according to a type of the virtual device set in the device type setting area 141.

In addition, the device failure condition setting screen W3 has a sheet transit setting area 143 for setting whether a failure of a virtual device occurs when what number of virtual sheets pass, and a failure state setting area 144 for sets how a virtual device acts at the time of failure occurrence.

It is possible to set failure occurrence conditions of a virtual device by various combination of the type of a virtual device, ID of the virtual device, number of passed times of virtual sheets, and failure state which are set in respective setting areas 141 to 144.

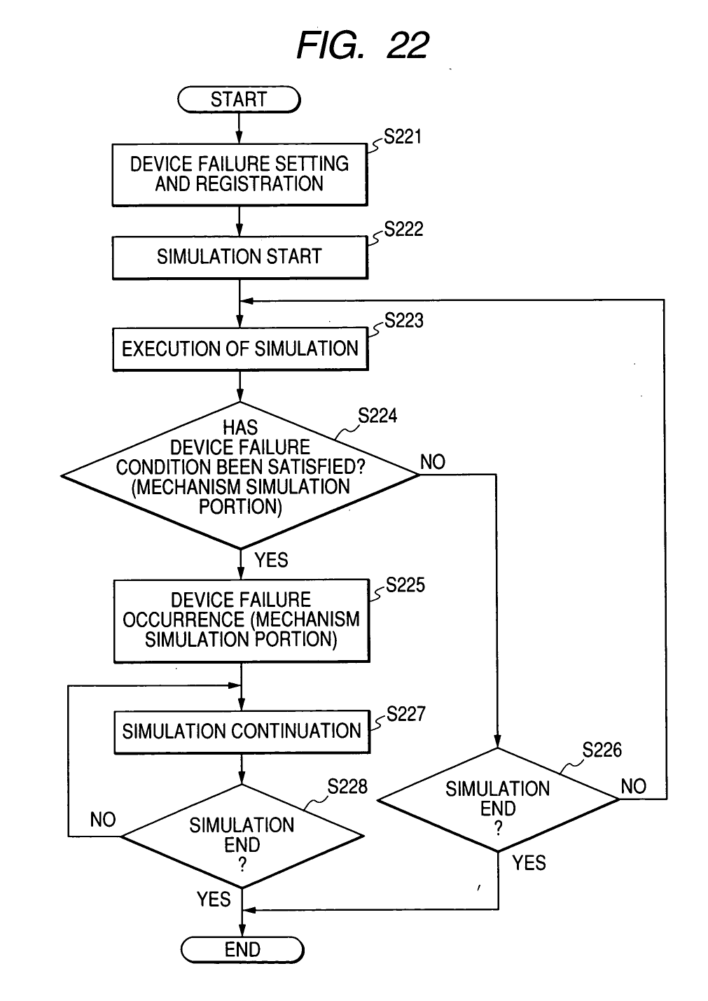

Next, a flow of device failure occurrence of the entire design support apparatus in this embodiment will be described using FIG. 22.

First, the failure occurrence conditions of a virtual device is set in the device failure setting and registration portion 130 before the simulation start of sheet conveyance, and the set failure occurrence conditions are registered in the device failure information management portion 131 (S221).

Next, the simulation start of sheet conveyance is instructed with the keyboard 3 or the like. According to the start instruction of this sheet conveying simulation, the software simulation portion 1 and mechanism simulation portion 2 are operated, and simulation is started (S222).

On the basis of an instruction of the software simulation portion 1, the drive control of a virtual device in the mechanism simulation portion 2 is performed, and a virtual sheet is conveyed. According to a position of the virtual sheet conveyed, the positional information of the virtual sheet is reported to the software simulation portion 1, and sheet conveying simulation is executed (S223).

Next, it is judged whether the failure occurrence conditions of the virtual device are satisfied, by conveyance control of the virtual sheet performed in the mechanism simulation portion 2 (S224). For example, it is judged whether the virtual sheet reaches the position which fulfills the failure occurrence conditions of the virtual device set beforehand, with a position of the virtual sheet being calculated.

When the failure occurrence conditions of the virtual device are satisfied at step S224, the mechanism simulation portion 2 generates a failure state, registered in the device failure information management portion 131, to the designated virtual device (S225).

After the failure of the virtual device occurs at step S225, the sheet conveying simulation is continued (S227), and when there is a request of end of simulation, all the processing is terminated (S228)

On the other hand, when the failure occurrence conditions of the virtual device are not satisfied at step S224, a request of end of simulation is judged, and when there is an end request, all the processing is terminated (S226).

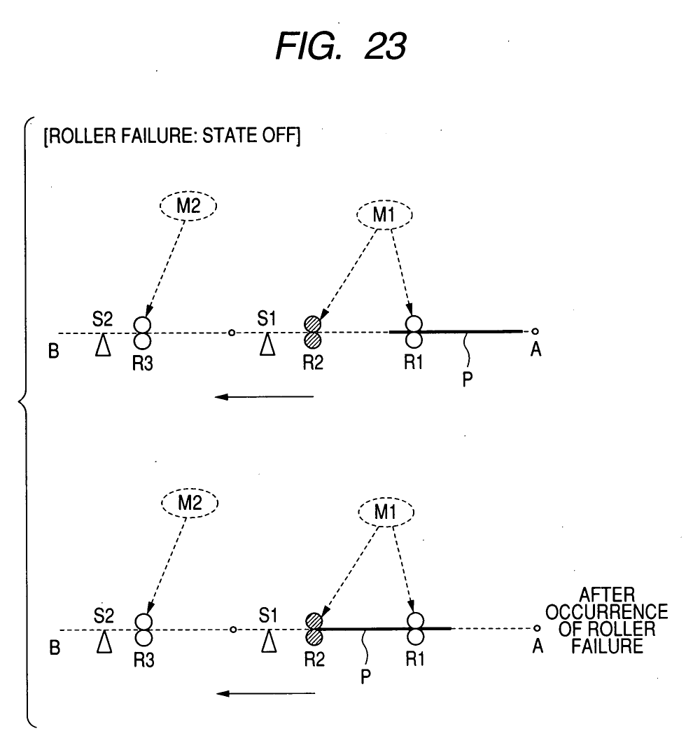

Next, using FIG. 23, a failure model that the virtual roller becomes off and breaks down will be described with conforming to actual simulation operation. The constitution of FIG. 23 is an example of arrangement of various devices relating to sheet conveyance control. Here, it is assumed that a virtual roller R2 is the broken virtual roller and that the state of the failure is OFF, which are registered in the device failure setting and registration portion 130.

In a position shown in an upper drawing of FIG. 23, the virtual sheet P is conveyed in the continuous arrow direction on the path AB by the virtual roller R1. The virtual roller R1 is driven by the virtual motor M1. As shown in a lower drawing of FIG. 23, a failure occurs in the timing when an edge of the virtual sheet P passes the virtual roller R2, and the virtual roller R2 becomes in an OFF state compulsorily hereafter.

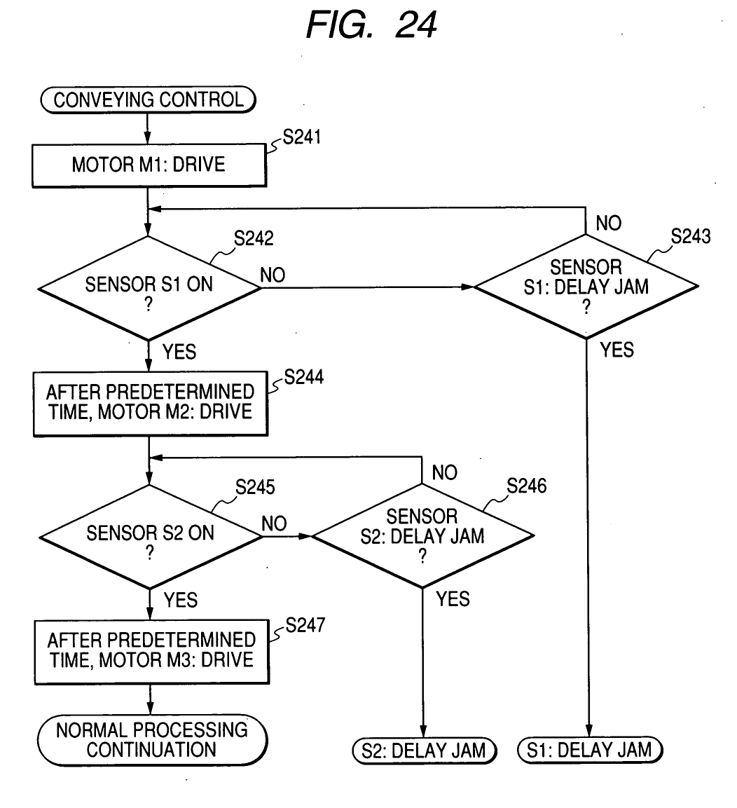

At this time, the firm software portion 10 performs sheet conveyance control according to the flowchart of FIG. 24. When the virtual sheet P arrives at a predetermined position, the virtual motor M1 is turned on (S241).

Next, it is waited that the virtual sensor S1 is turned on (S242). When the virtual sensor S1 is not turned on, it is judged whether a delay jam occurs in the virtual sensor S1 (S243).

Here, although the virtual sheet P is conveyed by the virtual roller R1 in a position shown in the upper drawing, in a position shown in the lower drawing, the virtual roller R2 is compulsorily turned off (stopped) by the mechanism simulation portion 2. For this reason, the edge of the virtual sheet stops in the position of R2, and the virtual sensor S1 has been never turned on. Thus, since the virtual sensor S1 is not turned on in predetermined timing from a sensor (not shown) in the upstream of the virtual sensor S1, it becomes a delay jam.

When a failure does not occur on the virtual roller R2, the virtual motor M2 is driven after regulation time from the turning-on of the virtual sensor S1 (S244), and it is waited that the virtual sensor S2 is turned on (S245). When the virtual sensor S2 has not been turned on, it is judged whether the delay jam occurs on the virtual sensor S2 (S246). When the virtual sensor S2 is turned on at step S245, a virtual motor M3 is driven after regulation time (S247), and normal processing is continued.

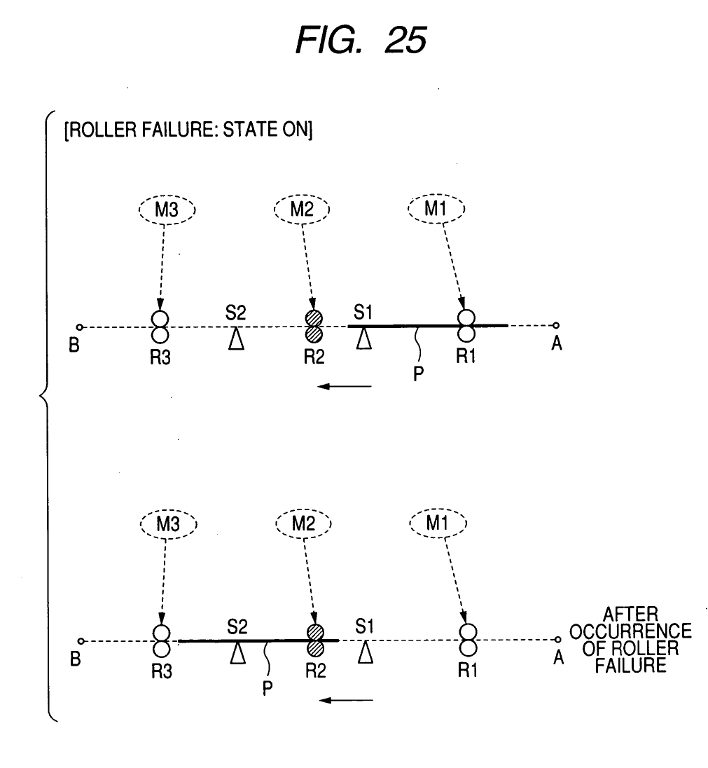

Next, a failure model that a virtual roller is turned on and breaks down will be described using FIG. 25. Here, it is assumed that the virtual roller R2 is the broken virtual device, that a state of a failure is ON, and that these are registered in the device failure setting and registration portion 130.

In an upper drawing of FIG. 25, the virtual sheet P is conveyed in the continuous arrow direction on the path AB by the virtual roller R1. The virtual roller R1 is driven by the virtual motor M1. As shown in a lower drawing of FIG. 25, a failure occurs in the timing when an edge of the virtual sheet P passes the virtual roller R2, and the virtual roller R2 becomes in an ON state compulsorily hereafter.

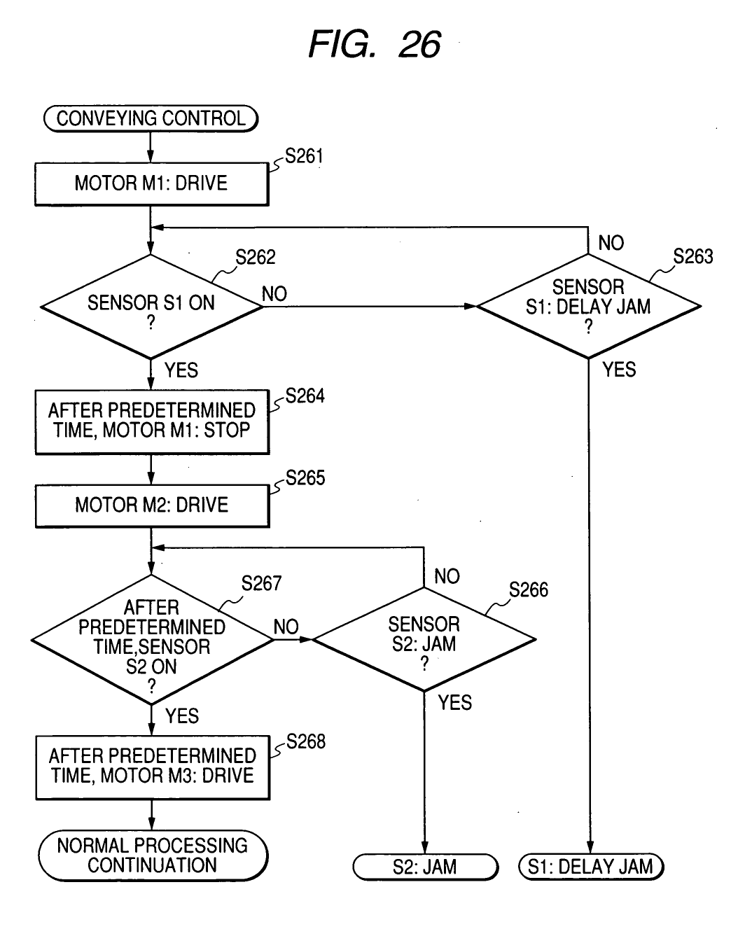

At this time, the firm software portion 10 performs sheet conveyance control according to the flowchart of FIG. 26. When the virtual sheet P arrives at a predetermined position, the virtual motor Ml is turned on (S261). Next, it is judged whether the virtual sensor S1 is turned on (S262).

At step S262, if the virtual sensor S1 does not turn on within the regulation time, it is judged that the delay jam occurs in the virtual sensor S1 (S263). When it is judged that the virtual sensor S1 is turned on at step S262, the virtual motor M1 is stopped after regulation time (S264), and the virtual motor M2 is driven (S265).

After the virtual motor M2 is driven at step S265, it is judged after regulation time whether the virtual sensor S2 is turned on (S267). When the virtual sensor S2 has not been turned on, it is judged whether a jam occurs on the virtual sensor S2 (S266).

Here, when the edge of the virtual sheet P reaches the virtual roller R2 at step S264, a failure of the virtual roller R2 occurs and the virtual roller R2 is compulsorily turned on. For this reason, the virtual sheet P is conveyed by the virtual roller R2, and since the time when the virtual sensor S2 arrives becomes earlier than a design value, it is judged to be a jam on the virtual sensor S2.

When a jam does not occur on the virtual sensor S2, the virtual motor M3 is driven after regulation time (S268), and normal processing is continued.

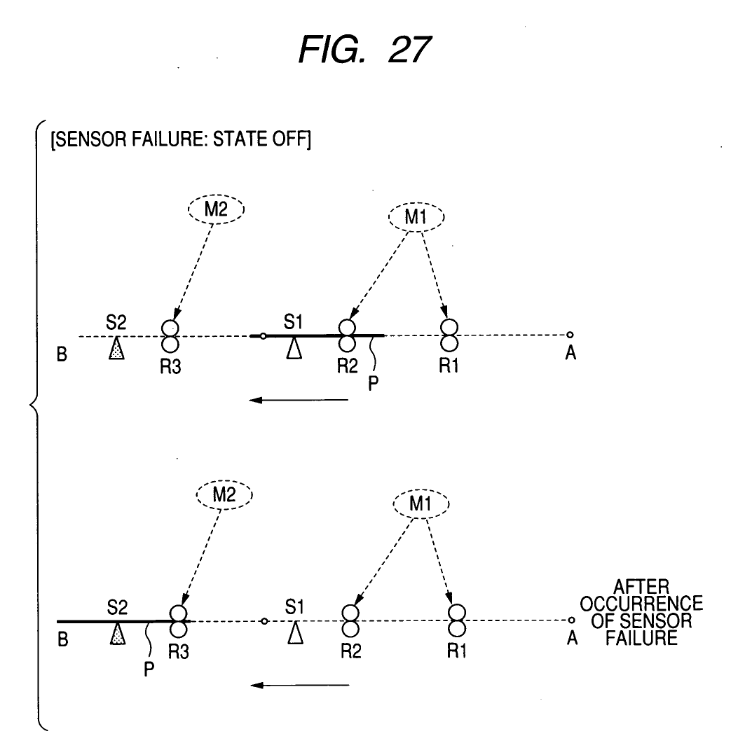

Next, a failure model that a virtual sensor is turned off and breaks down will be described using FIG. 27. Here, it is assumed that a virtual sensor S2 is the broken virtual sensor and that the state of the virtual sensor is OFF, which are registered in the device failure setting and registration portion 130.

In an upper drawing of FIG. 27, the virtual sheet P is conveyed in the continuous arrow direction on the path AB by the virtual roller R2. The virtual roller R2 is driven by the virtual motor M2. As shown in a lower drawing of FIG. 27, a failure occurs in the timing when the edge of the virtual sheet P passes the virtual sensor S2, and the virtual sensor S2 becomes in an OFF state compulsorily hereafter.

At this time, the firm software portion 10 performs sheet conveyance control according to the flowchart of FIG. 24 mentioned above. In the case of this example, when the edge of the virtual sheet P reaches the virtual sensor S2, an OFF failure of the virtual sensor S2 occurs. Therefore, even if the position of the virtual sheet P progresses, the virtual sensor S2 is not turned on. That is, since the virtual sensor S2 does not turn on within the regulation time, it is judged that the delay jam occurs on the virtual sensor S2 (S246).

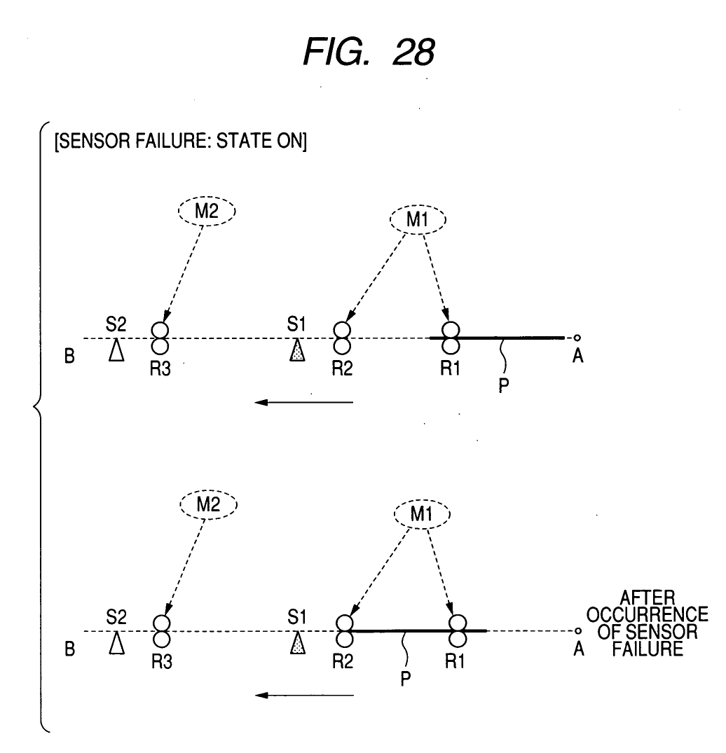

In addition, a failure model that a virtual sensor is turned on and breaks down will be described using FIG. 28. Here, it is assumed that the virtual sensor S1 is the broken virtual sensor and that the state of the failure is ON, which are registered in the device failure setting and registration portion 130.

In an upper drawing of FIG. 28, the virtual sheet P is conveyed in the continuous arrow direction on the path AB by the virtual roller R1. As shown in a lower drawing of FIG. 28, a failure occurs in the timing when the edge of the virtual sheet P arrives at the virtual sensor S1, and the virtual sensor S1 becomes in an ON state compulsorily hereafter.

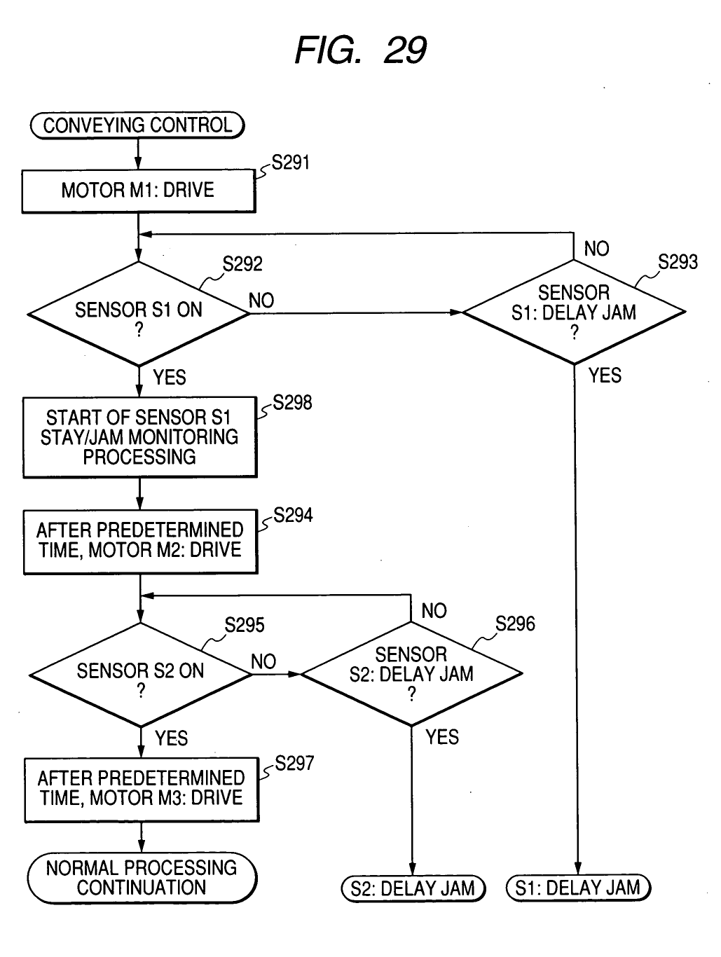

At this time, the firm software portion 10 performs sheet conveyance control according to the flowchart of FIG. 29. Here, processing at steps S291 to S297 in FIG. 29 performs the same processing as steps S241 to S247 in FIG. 24.

Although the processing at steps S291 to step S292 is similar to that in FIG. 24, step S298 is added after step S292. When the virtual sensor S1 is turned on at step S292, the stay/jam monitoring processing of the virtual sensor S1 is started (S298).

Then, although the processing after step S294, is performed, the stay/jam monitoring processing of the virtual sensor Si started at step S298 is performed in parallel to the processing after step S294 by the firm software portion 10.

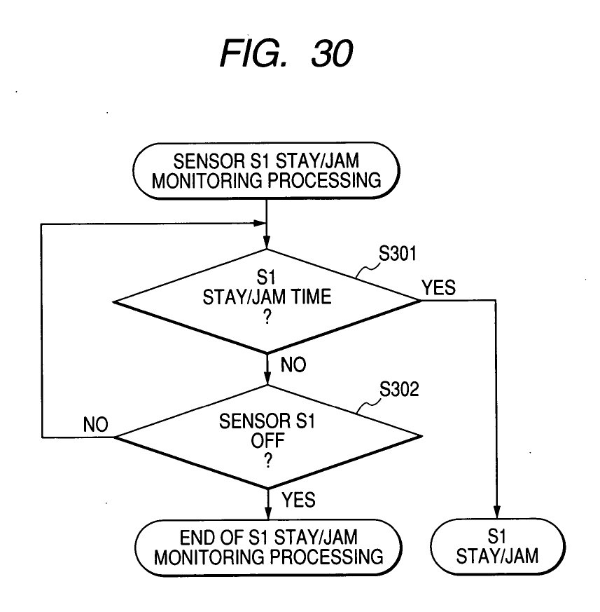

Next, the stay jam monitoring processing of the sensor S1 will be described using the flowchart of FIG. 30. First, it is judged whether regulation time elapses since the stay jam monitoring processing of the sensor S1 is started (S301).

Then, it is judged whether the virtual sensor S1 became OFF (S302), and the processing is terminated when becoming OFF. However, if the virtual sensor S1 does not turn off, the process returns to step S301 and the stay/jam monitoring processing of the sensor S1 is repeated.

Here, at step S292 of FIG. 29, since the failure that the virtual sensor S1 becomes ON after the edge of the virtual sheet P arrives at the virtual sensor S1, even if the regulation time elapses, the virtual sensor S1 does not turn off at step S301. Hence, it is judged that it is a stay jam.

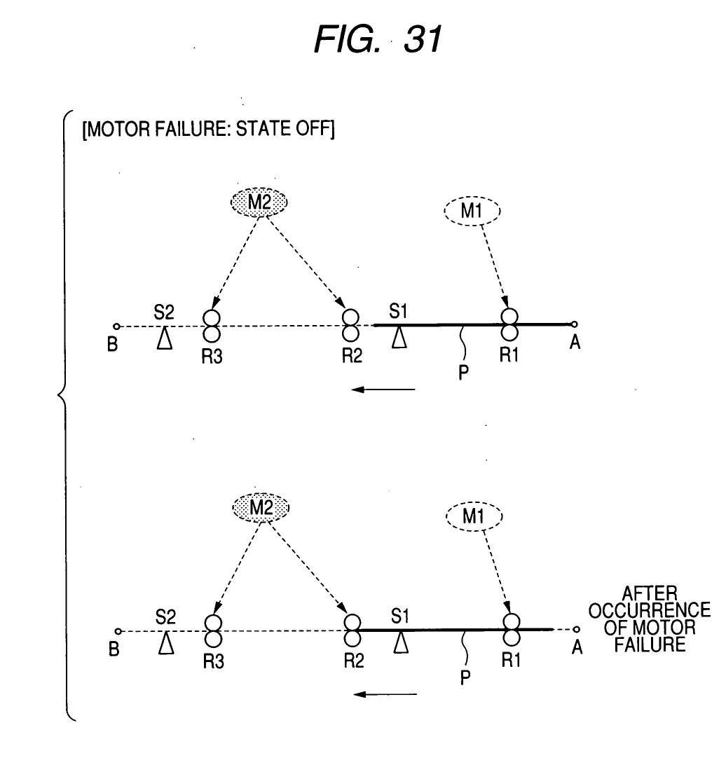

In addition, a failure model that a virtual motor is turned off and breaks down will be described using. FIG. 31. Here, it is assumed that the virtual motor M2 is the broken virtual motor and that the state of the failure is OFF, which are registered in the device failure setting and registration portion 130.

Since a virtual motor does not have a position on a conveying path, a position of a virtual roller which the virtual motor drives is dealt as a position of the virtual motor. In addition, when there are two or more virtual rollers which a virtual motor drives, a position of an upstream virtual roller is dealt as a position of the virtual motor. That is, since it is assumed that the virtual motor M2 is a virtual device where a failure occurs, the timing when the edge of the virtual sheet P arrives at the position of the virtual roller R2 serves as a trigger of device failure occurrence.

In an upper drawing of FIG. 31, the virtual sheet P is conveyed in the continuous arrow direction on the path AB by the virtual roller R1. As shown in a lower drawing of FIG. 31, a failure that the virtual motor M2 becomes in an OFF (stop) state occurs in the timing when the edge of the virtual sheet P arrives at the virtual roller R2. Hence, since the virtual motor M2 is turned off, the virtual roller R2 also stops simultaneously. The virtual motor M2 becomes in an OFF state compulsorily hereafter. Since simulation operation is the same as that in the case of the above-mentioned roller-OFF failure, description is omitted.

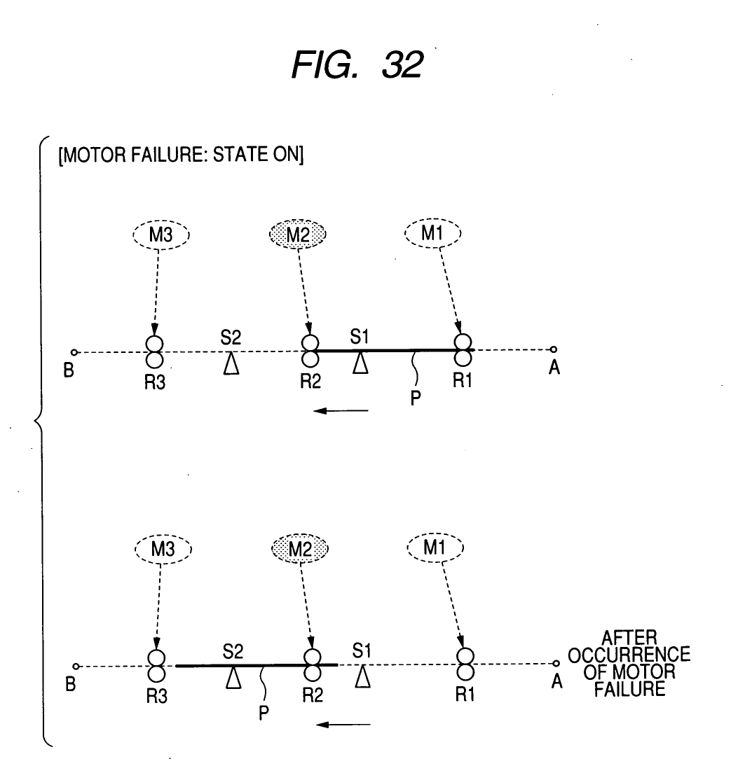

Next, a failure model that a virtual motor is turned on and breaks down will be described using FIG. 32. Here, it is assumed that the virtual motor M2 is the broken virtual motor and that the state of the failure is a driving state, which are registered in the device failure setting and registration portion 130.

In an upper drawing of FIG. 32, the virtual sheet P is conveyed in the continuous arrow direction on the path AB by the virtual roller R1. The virtual roller R1 is driven by the virtual motor M1. As shown in a lower drawing of FIG. 32, a failure that the virtual motor M2 becomes in a driving state occurs in the timing when an edge of the virtual sheet P passes the virtual roller R2, and the virtual motor M2 and virtual roller R2 becomes in a driving state compulsorily hereafter. Since simulation operation is the same as that in the case of the above-mentioned roller-ON failure, description is omitted.

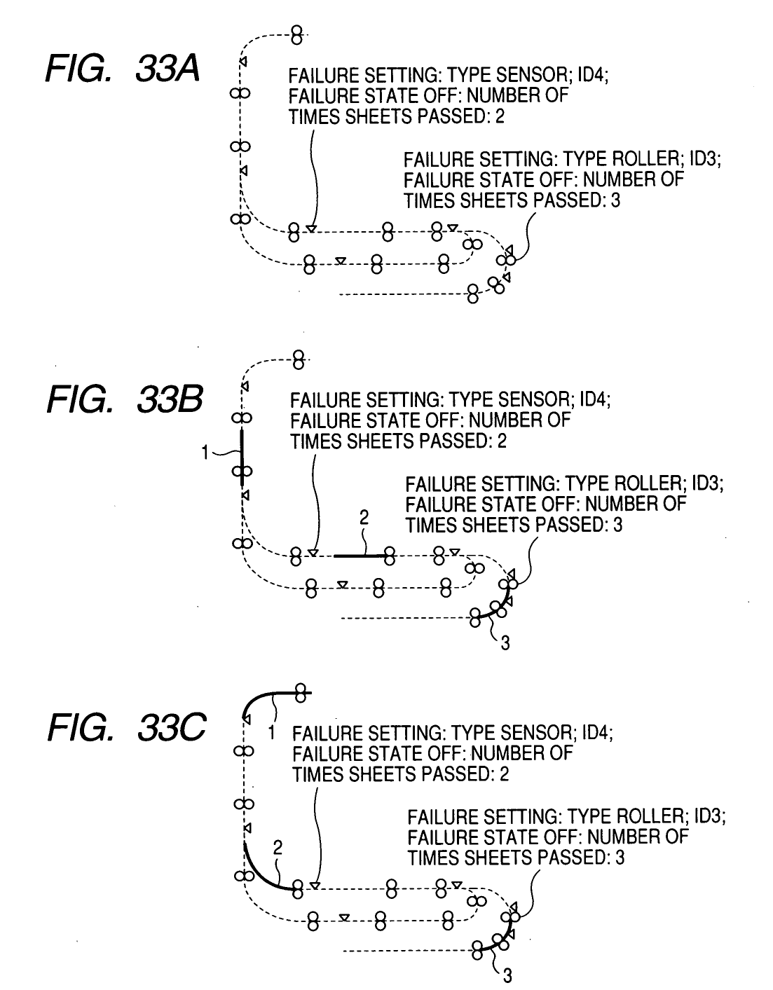

Simulation in the case that failures of virtual devices occur in two or more places will be explained using FIGS. 33A to 33C. In this embodiment, it is accepted that the failure setting of virtual devices is plural.

First, as shown in FIG. 33A, failures of virtual devices are set in a plurality of locations. In this example, failures of a virtual sensor and a virtual roller are set as follows.

1. Type of Failed Device: Sensor (ID4), Number of Sheet passing Times: 2, Failure State: OFF

2. Type of Failed Device: Roller (ID3), Number of Sheet passing Times: 3, Failure State: OFF

Next, simulation operation is started as shown in FIG. 33B. In this diagram, the sheet conveyance of two or more sheets is executed. When the simulation operation is executed, as shown in FIG. 33C, a failure of the set virtual device occurs in each location by making the number of passing times of a virtual sheet a trigger, and a jammed state occurs.

Furthermore, in the jams generated in the case of all the above-described device failures, popup display is performed on the conveying simulation screen W1 by making jam information each warning message. In addition, it is also good to perform display on the sheet conveying simulation screen W1 with changing a form and color of a sheet so that a position in and a number of sheets at which the jam occurs may be known. Although not shown, it is also acceptable to mark the position where the jam occurs.

As described above, according to this embodiment, it is possible to perform efficiently the operation verification of the conveying mechanism control software at the time of a device failure.

### Embodiment 5

Next, a fifth embodiment will be described. Also in this embodiment, conditions that a failure occurs are set beforehand, and when the set conditions are reached, a failure state is generated. Nevertheless, this differs in that sheet conveying simulation is displayed on a touch-sensitive panel display 50 which is provided in the operating portion 17 of an image forming apparatus.

In addition, in this embodiment, since a conveyance state of a sheet, an occurrence state of a jam, and a failure state of a device are displayed on the touch-sensitive panel display 50 with making the sheet actually conveyed by a roller, the expression “virtual” is not used.

Since it is the same as that of above-mentioned FIG. 15, the description of the design support apparatus relating to this embodiment is omitted. The design support apparatus of this embodiment can display a sheet conveyance state of an image forming apparatus within the image forming apparatus, and is used for supporting a control timing design of firm software which controls the image forming apparatus.

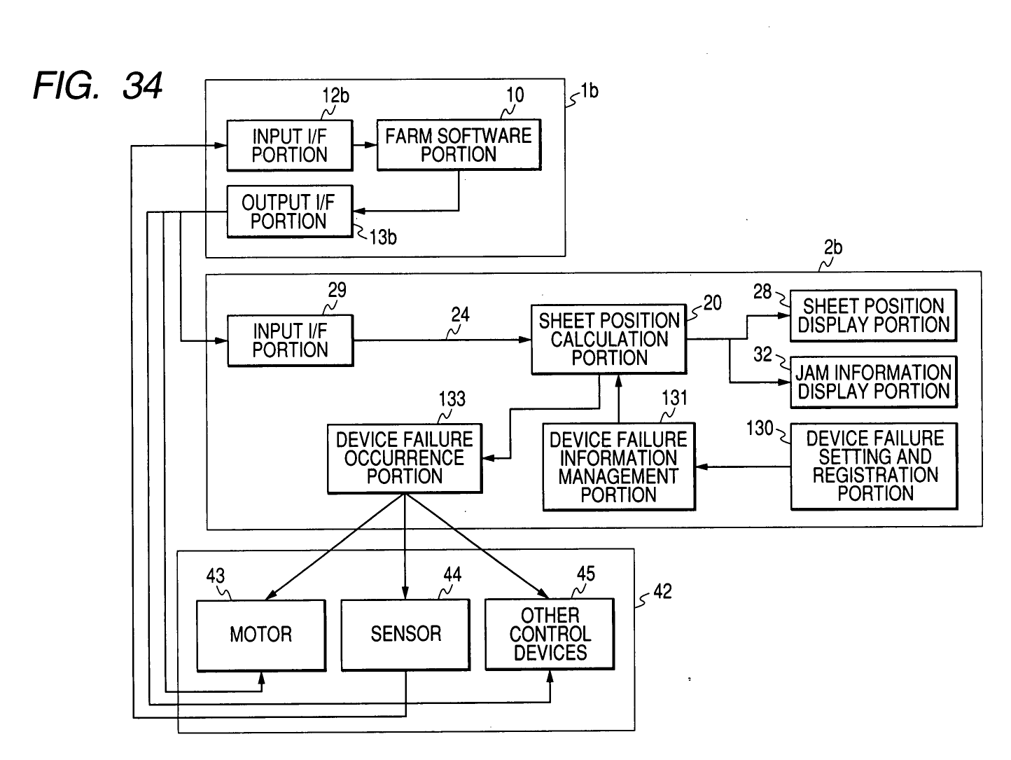

FIG. 34 shows an aspect of the software portion 1b, mechanism monitor portion 2b, and sheet conveying mechanism 42 of the design support apparatus of this embodiment.

The software portion 1b is constituted of the firm software portion 10, input I/F portion 12b, and output I/F portion 13b. The firm software portion 10 is software for performing sheet conveyance control of the image forming apparatus.

The input I/F portion 12b is a portion of inputting information from the sheet conveying mechanism 42. The output I/F portion 13b is a portion of outputting information to the sheet conveying mechanism 42 and mechanism monitor portion 2b.

The mechanism monitor portion 2b is constituted of a device failure occurrence portion 133, the sheet position calculation portion 20, input I/F portion 29, device failure management portion 131, sheet position display portion 28, device failure setting and registration portion 130, and jam information display portion 32. Main structure is the same as that in the fourth embodiment.

In addition, the device failure occurrence portion 133 has a role of controlling a device to a failure state. Specifically, according to the judgment of the sheet position calculation portion 20 that the device failure conditions registered in the device failure information management portion 131 are satisfied during sheet conveying simulation, the device failure occurrence portion 133 searches a device which coincides with the device failure conditions of the image forming apparatus. Then, the device failure occurrence portion 133 controls the searched device to the set failure state directly. The sheet conveying mechanism 42 is constituted of the motors 43, sensors 44, and other control devices 45.

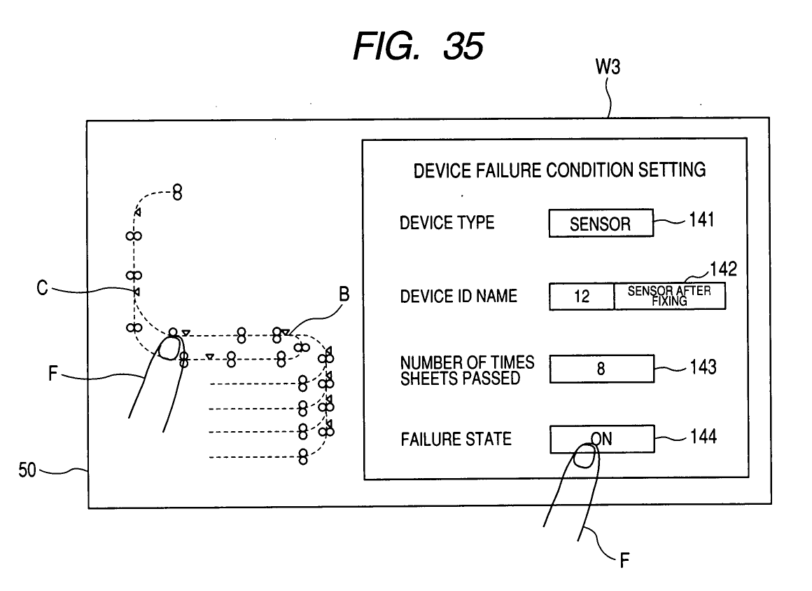

FIG. 35 is a drawing showing the device failure condition setting screen W3. This screen is displayed on the touch-sensitive panel display 50. Since the failure condition setting of a device is the same as that in the description of FIG. 21, it is omitted.

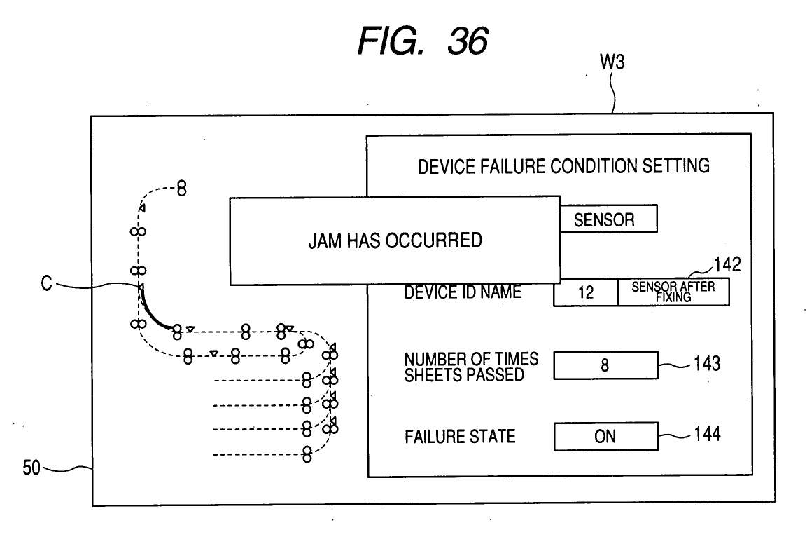

The firm software portion 10 performs sheet conveyance control by controlling the actual sheet conveying mechanism 42. When a device failure occurs, warning display shown in FIG. 36 is displayed on the touch-sensitive panel display 50 provided in the operating portion 17 shown in FIG. 16.

Device failure condition setting and registration as shown in FIG. 35 are not limited to the form, but, for example, it is also good to record it beforehand in a data file as setup data, and to read it before starting the design support apparatus according to this embodiment.

In addition, the warning display of FIG. 36 is not limited to the form, it is also good to attract a designer's attention, for example, by changing the color of a jam occurrence position, changing a shape, performing enlarged display, or displaying a marker, on the sheet conveying simulation screen W1 of FIG. 3.

Thus, according to this embodiment, it is possible to reproduce the occurrence of a device failure with a real system and to perform efficiently the operation verification of the conveying mechanism control software at the time of the device failure.

This application claims priorities from Japanese Patent Application No. 2004-310899 filed on Oct. 26, 2004, and 2005-194980 filed on Jul. 4, 2005, which are hereby incorporated by reference herein.

What is claimed is:

1. A design support program which enables verification of processing operation of software which controls a sheet conveying mechanism by displaying process, in which a virtual sheet is conveyed, on a display portion and which a computer is readable, comprising:
a first procedure of setting jam occurrence conditions of a virtual sheet beforehand;
a second procedure of judging whether the jam occurrence conditions set in the first procedure are satisfied; and
a third procedure of stopping conveyance of a virtual sheet when it is judged that the jam occurrence conditions are satisfied in the second procedure.

2. The design support program according to claim 1, wherein the jam occurrence conditions set in the first procedure are set by combining any conditions of a print mode, a number of sheets of virtual sheets, and a position where a jam occurs.

3. The design support program according to claim 1, comprising a fourth procedure of displaying on the display portion a warning that a jam occurs, when it is judged at the second procedure that the jam occurrence conditions are satisfied.

4. The design support program according to claim 3, wherein any information of a print mode, a number of sheets of virtual sheets, and a position where a jam occurs is displayed on the display portion in the fourth procedure.

5. The design support program according to claim 3, wherein a number of denoting what number virtual sheet is applied to a virtual sheet where a jam occurs and is displayed on the display portion in the forth procedure.

6. The design support program according to claim 3, wherein a virtual sheet where a jam occurs is displayed on the display portion with its color deferring from that of other virtual sheets, in the forth procedure.

7. The design support program according to claim 3, wherein a virtual sheet where a jam occurs is displayed on the display portion with its shape deferring from those of other virtual sheets, in the forth procedure.

8. The design support program according to claim 3, wherein a position where a jam occurs is displayed on the display portion with being marked, in the forth procedure.

9. The design support program according to claim 3, wherein a warning that a jam occurs is displayed on a display, accompanying the computer, in the fourth procedure.

10. The design support program according to claim 3, wherein a warning that a jam occurs is displayed on a display portion, provided in a image forming apparatus which forms an image on a sheet, in the fourth procedure.

11. The design support program according to claim 1, wherein it is judged in-the second procedure whether the jam occurrence conditions are satisfied, with making the image forming apparatus actually convey a sheet.

12. A design support method which enables verification of processing operation of software which controls a sheet conveying mechanism by displaying process, in which a virtual sheet is conveyed, on a display portion, comprising:
a first procedure of setting jam occurrence conditions of a virtual sheet beforehand;
a second procedure of judging whether the jam occurrence conditions set in the first procedure are satisfied; and
a third procedure of stopping conveyance of a virtual sheet when it is judged in the second procedure that the jam occurrence conditions are satisfied.

13. A design support program which enables verification of processing operation of software which controls a sheet conveying mechanism by displaying process, in which a virtual sheet is conveyed, on a display portion and which a computer is readable, comprising:
a first procedure of setting failure occurrence conditions of a virtual device beforehand;
a second procedure of judging whether the failure occurrence conditions set in the first procedure are satisfied; and
a third procedure of generating a failure of a virtual device when it is judged in the second procedure that the failure occurrence conditions are satisfied.

14. The design support program according to claim 13, wherein the failure occurrence conditions set in the first procedure are set by combining any conditions of a type of a virtual device, an ID of a virtual device, a number of passing times of a virtual sheet, and a failure state.

15. The design support program according to claim 13, comprising a fourth procedure of judging whether a jam occurs after a failure of the virtual device occurs in the third procedure.

16. The design support program according to claim 15, comprising a fifth procedure of displaying on the display portion a warning that a jam occurs, when it is judged at the fourth procedure that a jam occurs.

17. The design support program according to claim 16, wherein a number of denoting what number virtual sheet is applied to a virtual sheet where a jam occurs and is displayed on the display portion, in the fifth procedure.

18. The design support program according to claim 16, wherein a virtual sheet where a jam occurs is displayed on the display portion with its color deferring from that of other virtual sheets, in the fifth procedure.

19. The design support program according to claim 16, wherein a virtual sheet where a jam occurs is displayed on the display portion with its shape deferring from those of other virtual sheets, in the fifth procedure.

20. The design support program according to claim 16, wherein a position where a jam occurs is displayed on the display portion with being marked, in the fifth procedure.

21. The design support program according to claim 16, wherein a warning that a jam occurs is displayed on a display accompanying the computer, in the fifth procedure.

22. The design support program according to claim 16, wherein a warning that a jam occurs is displayed on a display portion provided in a image forming apparatus which forms an image on a sheet, in the fifth procedure.

23. The design support program according to claim 13, wherein it is judged in the second procedure whether the failure occurrence conditions are satisfied, with making the image forming apparatus actually convey a sheet.

24. A design support method which enables verification of processing operation of software which controls a sheet conveying mechanism by displaying process, in which a virtual sheet is conveyed, on a display portion, comprising:
a first procedure of setting failure occurrence conditions of a virtual device beforehand;
a second procedure of judging whether the failure occurrence conditions set in the first procedure are satisfied; and
a third procedure of generating a failure of a virtual device when it is judged in the second procedure that the failure occurrence conditions are satisfied.
